(19) United States
(12) Patent Application Publication
(10) Pub. No.: US 2012/0322517 A1
(43) Pub. Date: Dec. 20, 2012

(54) RESILIENT MATERIAL PROVIDING SHOCK ABSORPTION, OBJECTS TO WHICH SUCH A RESILIENT MATERIAL IS APPLIED, METHODS OF FORMING SUCH A RESILIENT MATERIAL, AND A METHOD OF DISTRIBUTING OBJECTS TO WHICH SUCH A RESILIENT MATERIAL IS APPLIED

(76) Inventor: Jeffrey J. Valdez, Beverly Hills, CA (US)

(21) Appl. No.: 13/160,502

(22) Filed: Jun. 14, 2011

(51) Int. Cl. H04W 88/02; B29C 65/72; B05D 3/12

(52) U.S. Cl. 455/575.8; 427/271; 427/277; 156/304.2

(57) ABSTRACT

In some embodiments, a mobile device accessory has a mobile device cover defining a mobile device receiving region, and a resilient material on the mobile device cover. The resilient material defines a plurality of peaks extending generally away from the mobile device receiving region. The plurality of peaks increase the surface area of the mobile device cover and provide shock absorption. Other objects having such a resilient material, and methods of making and distributing such objects, are also disclosed.

### BACKGROUND

Mobile devices have become an important part of every consumer and business person's world. They provide a broad array of ways to communicate via text, e-mail, voice and other types of communication.

One of the more important aspects of modern day mobile devices is their ability to store databases of information. Phone numbers, addresses, photos and videos are some of the important types of data that are stored. One of the problems that “mobile computer-type devices” suffer from is susceptibility to damage as a result of bumps and drops. At times, damage caused by bumps and drops can wipe out part or all of the data stored on the device, or cause hardware or software components to “crash”. Data recovery and device repair/replacement can be time-consuming and costly.

### BRIEF DESCRIPTION OF THE DRAWINGS

Illustrative embodiments of the invention are illustrated in the drawings, in which:

FIG. 1 illustrates an example of a method of forming a shock absorbing surface on an object;

FIG. 2 illustrates application of a liquid, pliable material to a surface of an object by flooding, painting or otherwise covering a portion of the surface with the liquid, pliable material;

FIG. 3 illustrates the use of a tool to contact the liquid, pliable material shown in FIG. 2 and form peaks by pulling the tool away from the liquid, pliable material;

FIGS. 4 & 5 illustrates use of an applicator tip to dispense a liquid, pliable material on a surface of an object, and to subsequently pull the material;

FIG. 6 illustrates the application of first and second liquid, pliable materials to a surface of an object;

FIG. 7 illustrates the application of a first quantity of liquid, pliable material as a coating on a surface of an object, and the application of a second quantity of liquid, pliable material in discrete quantities on the coating;

FIG. 8 illustrates a tumbler for putting a “tooth” on mobile phone covers;

FIG. 9 illustrates mobile phone covers held in place by a fixture;

FIG. 10 illustrates mobile phone covers with a coat of silicone primer thereon;

FIG. 11 illustrates a barrel and applicator tip of a pneumatic dispenser used to form a plurality of protrusions, mounds or slumped peaks on an object;

FIG. 12 illustrates a foot pedal of the pneumatic dispenser shown in FIG. 11;

FIG. 13 provides a close-up view of the applicator tip shown in FIG. 11;

FIG. 14 illustrates an air brush for painting the silicone deposited on an object;

FIG. 15 illustrates a curing chamber for silicone applied to objects;

FIG. 16 illustrates a heater of the curing chamber shown in FIG. 15;

FIG. 17 illustrates a humidifier of the curing chamber shown in FIG. 15;

FIGS. 18 & 19 illustrate two halves of a hard-shell case placed in a mold;

FIG. 20 shows an elevation of silicone applied to a surface of the hard-shell case shown in FIGS. 18 & 19;

FIGS. 21 & 22 illustrate the silicone applied to the surface shown in FIG. 20, after the silicone has been pulled up using an appropriate machine or tool;

FIGS. 23 & 24 illustrate finished mobile phone cases resulting at least partly from the steps illustrated in FIGS. 18-22;

FIGS. 25-27 illustrate steps of a method for making a floor tile;

FIGS. 28 & 29 illustrate elevations of floor tiles produced, at least in part, by the steps shown in FIGS. 25-27;

FIG. 30 illustrates a back view of a first mobile phone cover design (for an Apple iPhone 4), with the two pieces of the cover joined together;

FIG. 31 illustrates a front view of the cover shown in FIG. 30, with a mobile phone receiving region located in the central portion of the cover, and with the two pieces of the cover joined together;

FIG. 32 illustrates a left of the front side view of the cover shown in FIG. 30;

FIG. 33 illustrates a right of the front side view of the cover shown in FIG. 30;

FIG. 34 illustrates a top view of the cover shown in FIG. 30;

FIG. 35 illustrates a bottom view of the cover shown in FIG. 30;

FIG. 36 illustrates a back view of the cover shown in FIG. 30, with the two pieces of the cover separated from one another;

FIG. 37 illustrates a front view of the cover shown in FIG. 30, with the two pieces of the cover separated from one another;

FIG. 38 illustrates a perspective back view of the cover shown in FIG. 30;

FIG. 39 illustrates a back view of a second mobile phone cover design (for an Apple iPhone 4), with the two pieces of the cover joined together;

FIG. 40 illustrates a front view of the cover shown in FIG. 39, with a mobile phone receiving region located in the central portion of the cover, and with the two pieces of the cover joined together;

FIG. 41 illustrates a left of the front side view of the cover shown in FIG. 39;

FIG. 42 illustrates a right of the front side view of the cover shown in FIG. 39;

FIG. 43 illustrates a top view of the cover shown in FIG. 39;

FIG. 44 illustrates a bottom view of the cover shown in FIG. 39;

FIG. 45 illustrates a back view of the cover shown in FIG. 39, with the two pieces of the cover separated from one another;

FIG. 46 illustrates a front view of the cover shown in FIG. 39, with the two pieces of the cover separated from one another;

FIG. 47 illustrates a perspective back view of the cover shown in FIG. 39;

FIG. 48 illustrates a back view of a third mobile phone cover design (for an Apple iPhone 3G), with the two pieces of the cover joined together;

FIG. 49 illustrates a front view of the cover shown in FIG. 48, with a mobile phone receiving region located in the central portion of the cover, and with the two pieces of the cover joined together;

FIG. 50 illustrates a left of the front side view of the cover shown in FIG. 48;

FIG. 51 illustrates a perspective back view of the cover shown in FIG. 48;

FIG. 52 illustrates a top view of the cover shown in FIG. 48;

FIG. 53 illustrates a bottom view of the cover shown in FIG. 48;

FIG. 54 illustrates a back view of the cover shown in FIG. 48, with the two pieces of the cover separated from one another;

FIG. 55 illustrates a perspective front view of the cover shown in FIG. 48, with the two pieces of the cover separated from one another;

FIG. 56 illustrates a front view of the front half of a mobile device cover design (for an Apple iPad);

FIG. 57 illustrates a back view of the back half of the cover shown in FIG. 56;

FIG. 58 illustrates a right of the front side view of the cover shown in FIG. 56;

FIG. 59 illustrates a left of the front side view of the cover shown in FIG. 56;

FIG. 60 illustrates a perspective back view of the cover shown in FIG. 56, with the two pieces of the cover joined together;

FIG. 61 illustrates a back view of the back half of a portable music player cover design (for an Apple iPod Touch);

FIG. 62 illustrates a front view of the cover shown in FIG. 61, with the two pieces of the cover joined together;

FIG. 63 illustrates a back view of the front half of the cover shown in FIG. 61;

FIG. 64 illustrates a left of the front side view of the cover shown in FIG. 61;

FIG. 65 illustrates a perspective back view of the cover shown in FIG. 61, with the two pieces of the cover joined to one another;

FIG. 66 illustrates a top view of the cover shown in FIG. 61; and

FIG. 67 illustrates a bottom view of the cover shown in FIG. 61.

### DETAILED DESCRIPTION

### Summary

Described below is a textured material having a shock absorption characteristic, and in some instances, an anti-slip characteristic. The textured material is partly or wholly formed of a resilient or elastomeric material such as silicone, natural rubber or plastic (and in some instances, recycled rubber or plastic). The texture of the resilient or elastomeric material, when applied to an object, can take various forms. In some instances, the texture may be described as meringue-like (i.e., having peaks like the top of a meringue pie). In other instances, the texture of the resilient or elastomeric material may take the form of generally teardrop-shaped volumes having flattened bases and slumped peaks (though the tips of the peaks may in some cases stand erect or take other forms).

Depending on the composition of the material, and the method used to form its texture, the peaks of the texture may be more or less uniformly distributed, and may slump to a greater or lesser degree. Of importance, the material's texture can significantly increase the surface area of an object to which it is applied. The increased surface area and elastomeric properties of the material help to absorb shock in the event an object on which the textured material is formed or applied is dropped or bumped. Such shock absorption can protect the object from being damaged, or can protect someone or something that comes in contact with the textured material on the object from being injured or damaged. The increased surface area and elastomeric properties of the material can also give the object an anti-slip characteristic. The anti-slip characteristic can reduce the likelihood that the object itself will slip or slide on a surface, or can reduce the likelihood that someone or something stepping on (or placed on) the object will slip or slide on the object.

Examples of objects to which the textured material described herein can be applied include mobile devices such as mobile phones, cameras, portable music players, personal digital assistants, computing pads, and portable computers, as well as protective films and cases for protecting such objects. The textured material can also be applied to objects such as coffee cups and door handles. Still further, the textured material can be applied to stationary or semi-stationary objects, such as floors, walls and furniture. The textured material can also be applied to therapeutic items and toys, including shoe insoles, slippers, massage or toy balls, and massage rollers.

The textured material can be formed directly on an object such as a mobile phone or wall tile. Alternately, the material can be formed on a rigid or flexible cover for an object (e.g., the textured material may be formed on a mobile phone cover in which a mobile phone is encased). The material can also be formed in sheets having a tacky or adhesive backing, and then applied to part or all of one or more objects.

When formed on or applied to a mobile device or its cover, the textured material can protect the device from certain shocks that the device might otherwise suffer as a result of mishandling, drops, etc. The material can also protect the device from damage such as scrapes, scuffs and scratches.

When formed on or applied to an object such as a floor tile, the textured material can reduce the likelihood that a person will slip on the floor tile. The material can also reduce the risk of injury to a person that falls on the tile, or reduce the risk of damage to an object that is dropped on the tile.

In addition to its shock absorption and anti-slip characteristics, the material described below can provide a unique aesthetic value (in terms of both look and feel).

### An Embodiment of a Phone Case Including the Textured Material

In some embodiments, the textured material described herein may be formed on a thin, hard-shell case for a smart phone (e.g., iPhone®, Droid®, Blackberry®, etc.). The textured material may be formed of 100% silicone that is room temperature vulcanizing. However, the textured material is not limited to being formed of room temperature vulcanizing silicone, and in some cases may be formed using two part, heat cured silicone, or other materials or processes.

Upon curing the textured material, the case may be clipped onto the smart phone. In this manner, the smart phone is protected by both the textured material and the hard-shell case. The texture of the material is created by applying a material having a particular viscosity, slump, hardness and opacity to a surface, and then pulling on the material while it is still in a liquid/pliable state. This causes the material to pull up (or out) and slump down, thereby forming peaks or protrusions that are shaped similar to the slumped peaks of a meringue pie or the slumped peaks of chocolate kisses. Because the material is pulled up or out while it is in a liquid/pliable state, it typically makes sense to pull the material while it is in a horizontal plane. In some cases, however, interesting affects may be obtained by positioning the material such that it can be pulled from the side, at an angle, or from the bottom. The viscosity and slump of the material, along with machine, tool or hand-based procedures, creates peaks of varying size, direction and height.

### Properties of the Textured Material that can be Used to Protect a Mobile Phone

Traditional phone cases will protect a mobile device such as an iPod® or Blackberry® from getting scratched, but not from getting damaged. The textured material described herein, with its shock absorbing characteristics, greatly reduces the likelihood of a mobile device becoming damaged. The textured material is not only elastomeric, but significantly increases the surface area of the mobile device to which it is applied, thereby increasing its shock absorbing capacity in the event of a bump or drop. Structures of the mobile device, and data stored on the mobile device, are therefore better protected.

In addition to shock absorbance, the textured material has properties such as abrasion resistance; superior grip; impermeability and resistance to most common fluids; temperature resistance ranging, in some cases, from below freezing to over 300° F.; long life approaching 50 years; and a unique and original look and feel. The material can also be produced with a wide range of appearances, including, but not limited to, appearances that are transparent to opaque; dull to shiny; include one or more of millions of colors; are metallic; are iridescent; or are phosphorescent.

Mobile phones placed in cases covered with the textured material have been subjected to drop tests. The drop tests have demonstrated that the textured material provides shock absorbance that protects the phones from drops exceeding the parameters of those that would be expected during normal use or carry of the phones. The dropped phones (and the cases to which the textured material is applied) have not shown any evidence of abrasion.

The mobile phones placed in cases covered with the textured material have also been subjected to anti-slip tests. In some of these tests, phones have been placed on the dashboard of a moving car and have stayed put (i.e., not slid or slipped from the dashboard).

### Methods of Forming a Shock Absorbing Surface on an Object (Generally)

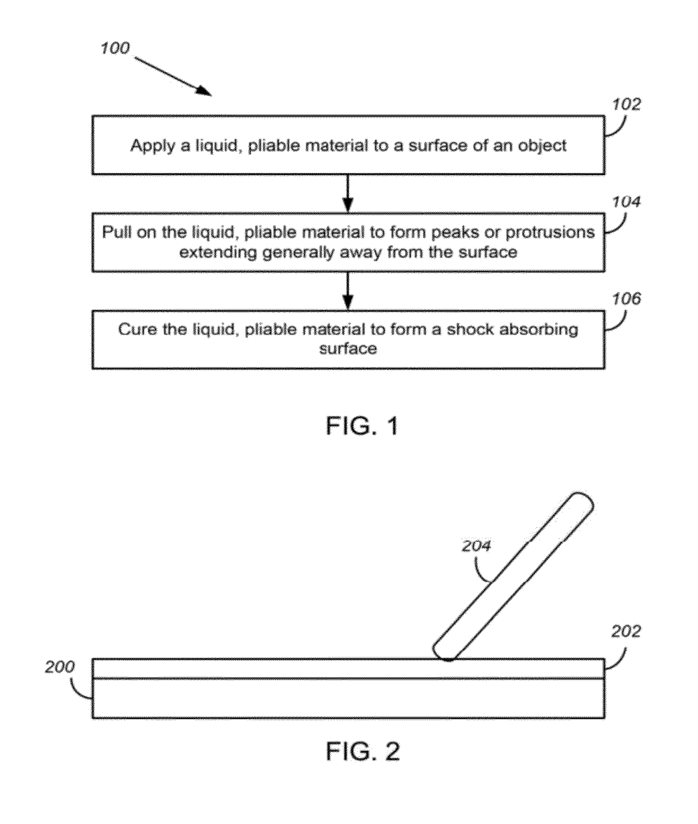

FIG. 1 illustrates a method 100 of forming a shock absorbing surface on an object. The method 100 comprises applying a liquid, pliable material to a surface of the object (at block 102), and then pulling on the liquid, pliable material to form protrusions (e.g., peaks) that extend generally away from the surface (at block 104). The method 100 continues with a curing of the liquid, pliable material to form the shock absorbing surface. The cured material comprises protrusions that are resilient, and in some cases elastomeric.

The liquid, pliable material may comprise a material such as silicone, natural rubber or plastic. In some cases, the material may be entirely silicone.

In some embodiments, the liquid, pliable material may be pulled at a viscosity and slump that cause the peaks or protrusions to slump. Depending on the viscosity and slump of the material, the entireties of the peaks or protrusions may slump, or just the ends of the protrusions (or tips of the peaks) may slump (e.g., droop).

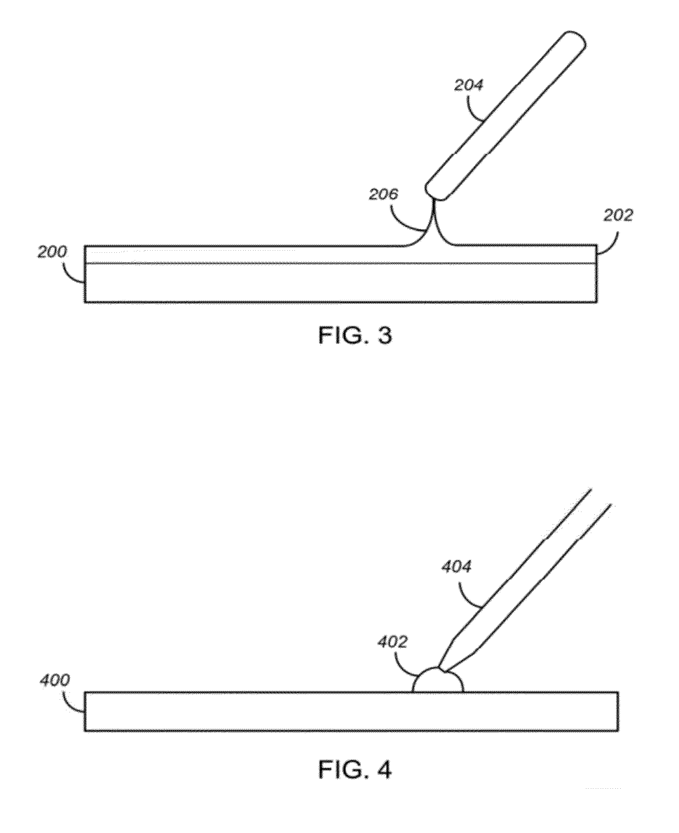

In some embodiments of the method 100, and as shown in FIGS. 2 & 3, the liquid, pliable material 202 may be applied to a surface of an object 200 by flooding, painting or otherwise covering a portion of the surface with the liquid, pliable material 202 (FIG. 2). A plate, rod, finger or other tool 204 may then be used to contact the liquid, pliable material 202, and peaks or protrusions 206 may be formed by pulling the plate, rod, finger or other tool 204 away from the liquid, pliable material 202 (FIG. 3). In some cases, the liquid, pliable material 202 may be contacted with the tool 204 multiple times, in the same or different areas, to form a desired type and distribution of peaks or protrusions. In some cases, a plate or other tool contacts the liquid, pliable material 202 multiple times, and a manner in which the plate or other tool 204 approaches the material, contacts the material, or is pulled away from the material is varied between contacts. By way of example, the orientation of the plate or other tool 204 with respect to the liquid, pliable material 202 may be varied, or the velocity at which the plate or other tool 204 is pulled away from the liquid, pliable material 202 may be varied.

In other embodiments of the method 100, and as shown in FIGS. 4 & 5, the liquid, pliable material 402 may also be applied to the surface of the object 400, and subsequently pulled, using an applicator tip 404 (e.g., a pipet or a syringe) connected to a pneumatic dispenser, wherein the pneumatic dispenser is controlled to apply multiple discrete quantities of the liquid, pliable material 402 to the object 400. The multiple discrete quantities of the material 402 can be applied in abutment to one another, with space therebetween, or in a somewhat random manner where some of the discrete quantities of material abut one another and others do not.

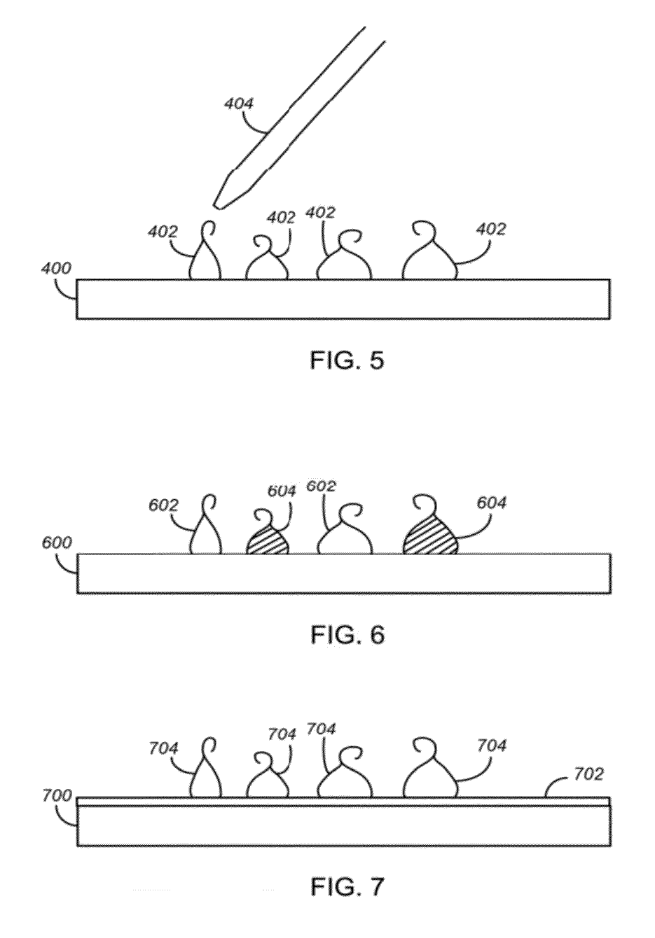

In still other embodiments of the method 100, and as shown in FIG. 6, the liquid, pliable material 602, 604 applied to the surface of an object 600 may include a first type of liquid, pliable material 602 and a second type of liquid, pliable material 604 (and possibly additional types of liquid, pliable material). By way of example, the different types of liquid, pliable material 602, 604 may have different viscosities, different slumps, or different colorants or design elements. The first type of liquid, pliable material 602 is applied in discrete quantities to portions of the surface of the object 600, and pulled, using a first applicator tip; and the second type of liquid, pliable material 604 is applied in discrete quantities to portions of the surface of the object 600, and pulled, using a second applicator tip. The discrete quantities of the first and second types of liquid, pliable material 602, 604 may be intermingled in a substantially non-overlapping manner, as shown in FIG. 6; or the discrete quantities of the first and second types of liquid, pliable material 602, 604 may be intermingled in an overlapping manner (not shown). By applying the different types of liquid, pliable materials 602, 604 in different ways, different design effects can be achieved. Different shock absorption and anti-slip characteristics can also be achieved.

FIG. 7 illustrates yet another manner of applying the liquid, pliable material 702, 704 to the surface of an object 700 in accord with the method 100. In FIG. 7, a first quantity of the liquid, pliable material 702 is applied as a coating on the surface of the object 700. A second quantity of the liquid, pliable material 704 is then applied in discrete quantities on the coating 702. The second quantity of the liquid, pliable material 704 may be applied, and then pulled, using an applicator tip. In some cases, the first and second quantities of the liquid, pliable material 702, 704 may have the same characteristics. In other cases, the first and second quantities of the liquid, pliable material may have differing characteristics, including differing viscosities, slumps, colorants and other design elements.

The liquid, pliable material may be pulled in varying directions, and with the object oriented in different ways. For example, the material may be pulled up while the liquid, pliable material is facing up with respect to gravitational pull. Alternately, the material may be pulled down while the liquid, pliable material is facing down with respect to gravitational pull. For purposes of this description, “up” and “down” are intended to include orientations and pulls that are generally up and generally down, with the liquid, pliable material being oriented at an upward or downward angle, or with the pull being made in an upward or downward direction. The material may also be pulled with the material facing to one side, with the pull being made in an upward, downward or sideways direction.

In some cases, a colorant, metallic flake or other design element may be mixed into the liquid, pliable material before it is applied to the object. The mixing may be done by machine or by hand. Hand-mixing can sometimes provide a more non-uniform distribution of the design element in the liquid, pliable material, thereby providing interesting effects. Alternately (or additionally), a colorant, metallic flake or other design element may be applied to the object itself, before the liquid, pliable material is applied to the object. Application of the design element directly on the object is typically more useful when the liquid, pliable material is transparent or translucent.

A colorant, metallic flake or other design element can also be applied to the liquid, pliable material after the liquid, pliable material has been applied to the object. The design element can sometimes be applied while the liquid, pliable material is still liquid and pliable, or after the liquid, pliable material has been cured—especially in the case of applying a colorant that is air-brushed or otherwise painted on the liquid or cured material.

### A First Particular Example of a Method of Forming a Shock Absorbing Surface on an Object

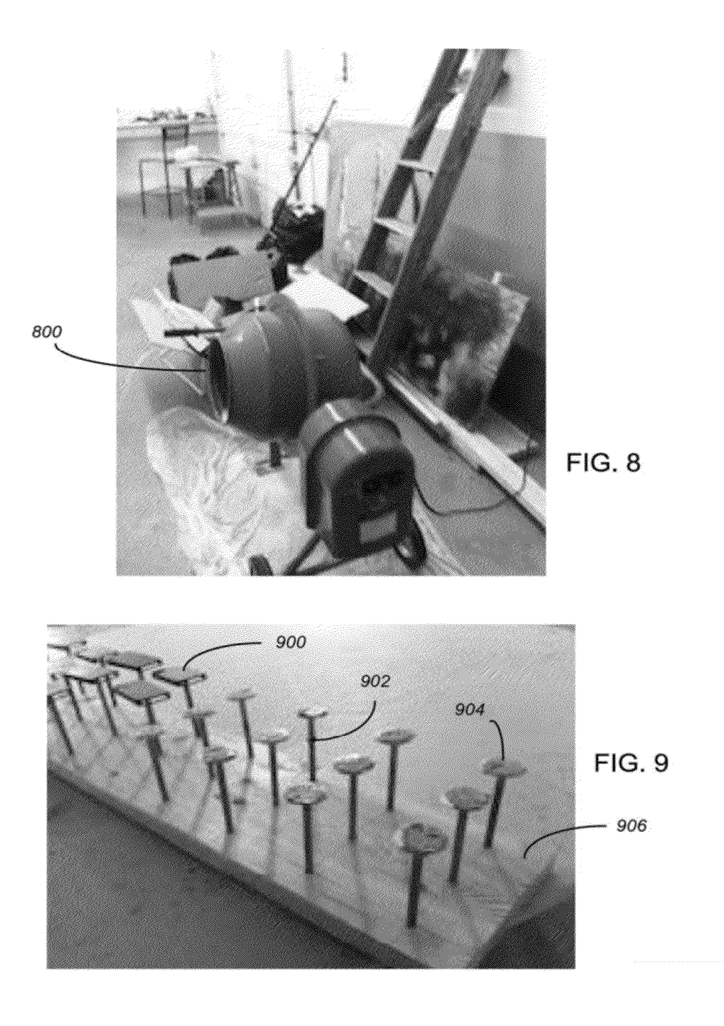

A first particular example of a method of forming a shock absorbing surface on an object is shown in FIGS. 8-17. By way of example, the method is disclosed in the context of forming a shock absorbing surface on a mobile device cover having a mobile device receiving region, and more particularly, forming a shock absorbing surface on a mobile phone cover.

The method begins with the selection of a mobile device cover. For purposes of illustration, and by way of example only, a hard-shell (e.g., acrylic) mobile phone cover (or case) having two pieces was selected. The hard-shell mobile phone cover has a plurality of panels (e.g., a back and four sides) that define the mobile device receiving region.

To improve adhesion of a liquid, pliable material to a batch of the mobile phone covers, the mobile phone covers may be pre-treated to put a “tooth” on them. For example, the mobile phone covers may be tumbled in a tumbler 800 with a medium grade soda blasting media for about 30-40 minutes. See, FIG. 8. This results in the covers taking on a dull cloudy finish, appearing as if they have been sanded, and eliminates the glossy or shiny surfaces that are put on the covers during manufacture. Instead of a tumbling operation, the covers could be sanded or buffed by hand, chemically treated, or otherwise roughened to put a “tooth” on them.

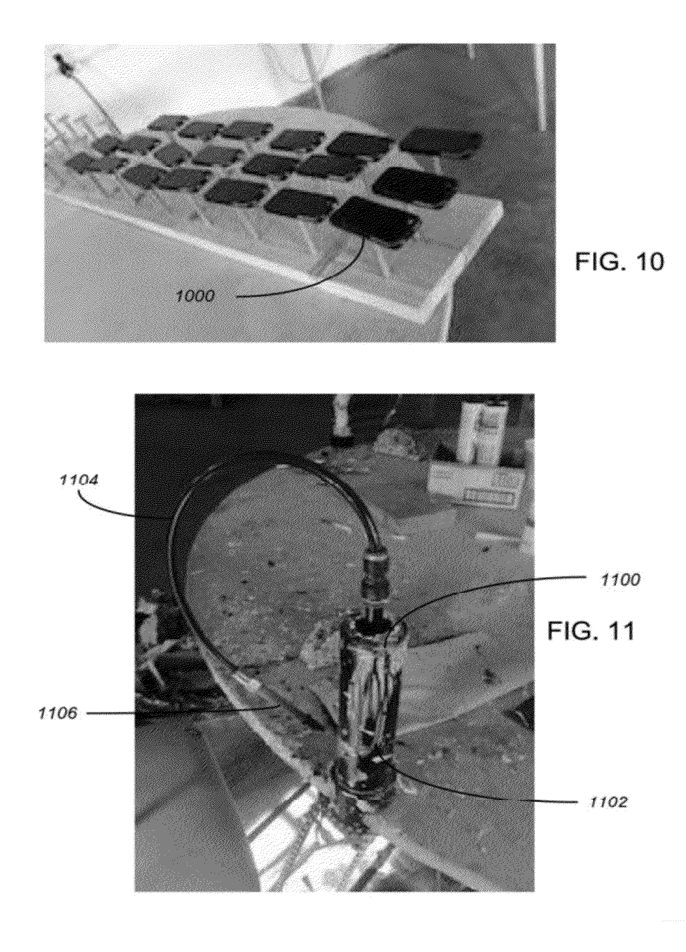

After being roughened, the covers are primed with a coat of silicone primer. As shown in FIG. 9, the covers 900 may be held in place during priming by a fixture, such as a fixture 906 having a plurality of rods 902 extending therefrom. At the end of each rod 902 is a washer 904 to which a non-stick adhesive coating is applied. After attaching a cover 900 to each of the washers 904, the silicone primer is coated on the exterior surfaces of the covers 900 using, for example, an applicator brush or sprayer. An example of a silicone primer is the Momentive Silicone Primer Solution (product no. SS4004P 01P), which comprises a silicone resin in solvents. The coated covers 1000 (FIG. 10) may then be cured. Cure times may range from about twenty minutes to twenty-four hours, and depend on the ambient conditions, the primer being used, and other factors known to those of ordinary skill in the art.

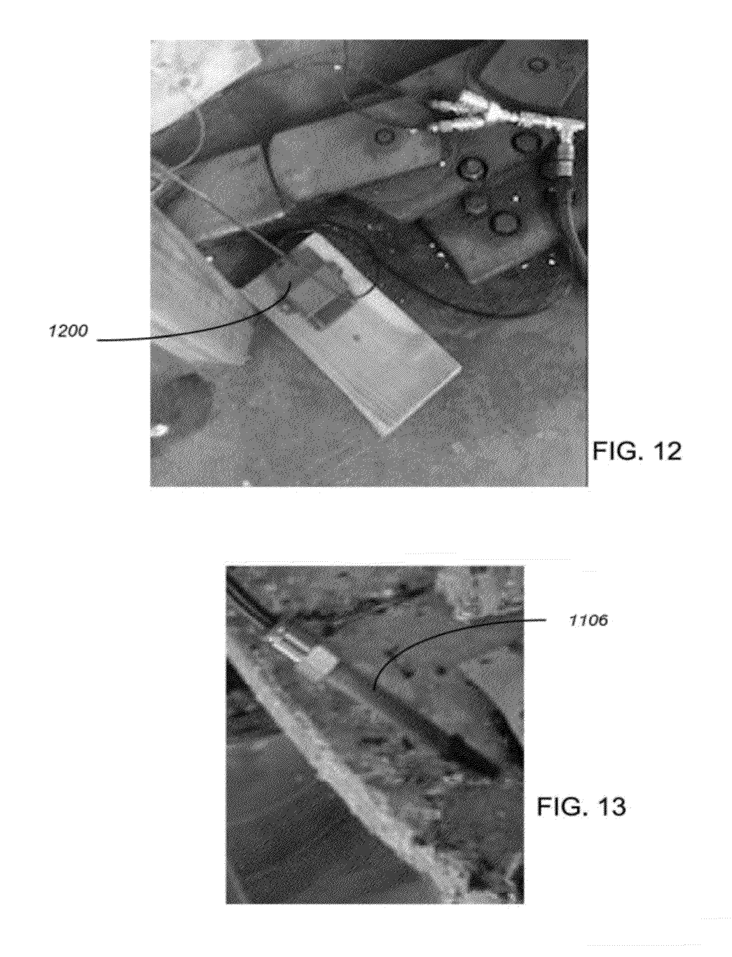

Next, a pneumatic dispenser 1100 (FIGS. 11-13) is used to form a plurality of protrusions, mounds or slumped peaks on the coat of silicone primer, as shown in FIG. 7. The pneumatic dispenser 1100 may in some cases be operated by a foot pedal 1200 that causes a controlled amount of silicone to be dispensed with each press on the foot pedal 1200. See, FIG. 12. The silicone may be provided in a tube, with the tube being held in a barrel 1102 of the pneumatic dispenser 1100. By way of example, the silicone may be General Electric 100% RTV Silicone 1. Upon pressing the foot pedal 1200, the silicone is squeezed from the barrel 1102, through a hose 1104, and ultimately out of an applicator tip 1106 (e.g., a pipet or syringe—see FIG. 13). Before each press of the foot pedal 1200, a user moves the applicator tip 1106 to a desired position on one of the mobile phone covers, and then pulls the applicator tip 1106 away from the mobile phone cover as a quantity of silicone is deposited on the mobile phone cover.

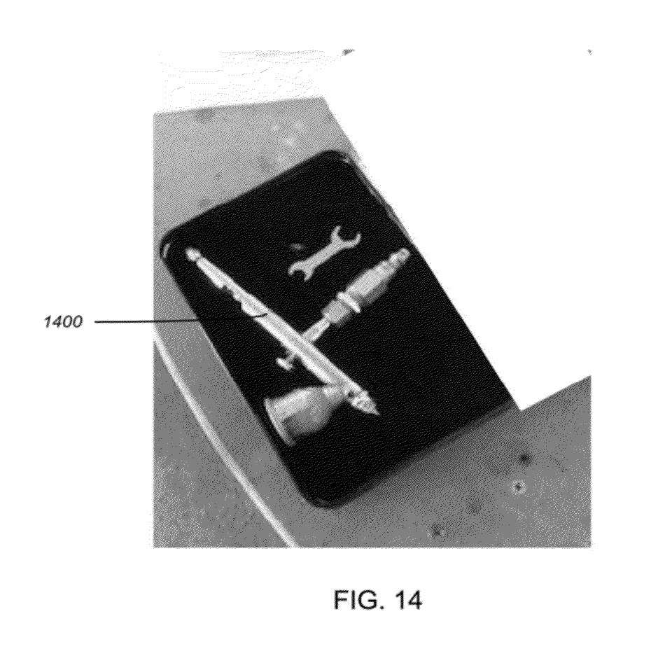

Following deposition of a plurality of generally teardrop-shaped volumes of silicone on the mobile phone cover, wherein at least some of the deposited volumes of silicone have flattened bases and slumped peaks (see the volume of silicone 704 shown in FIG. 7), the deposited silicone may be painted a desired color using, for example, an air brush 1400 such as the one shown in FIG. 14. Subsequently, the painted silicone may be sprayed with a clear silicone to keep the color from rubbing off.

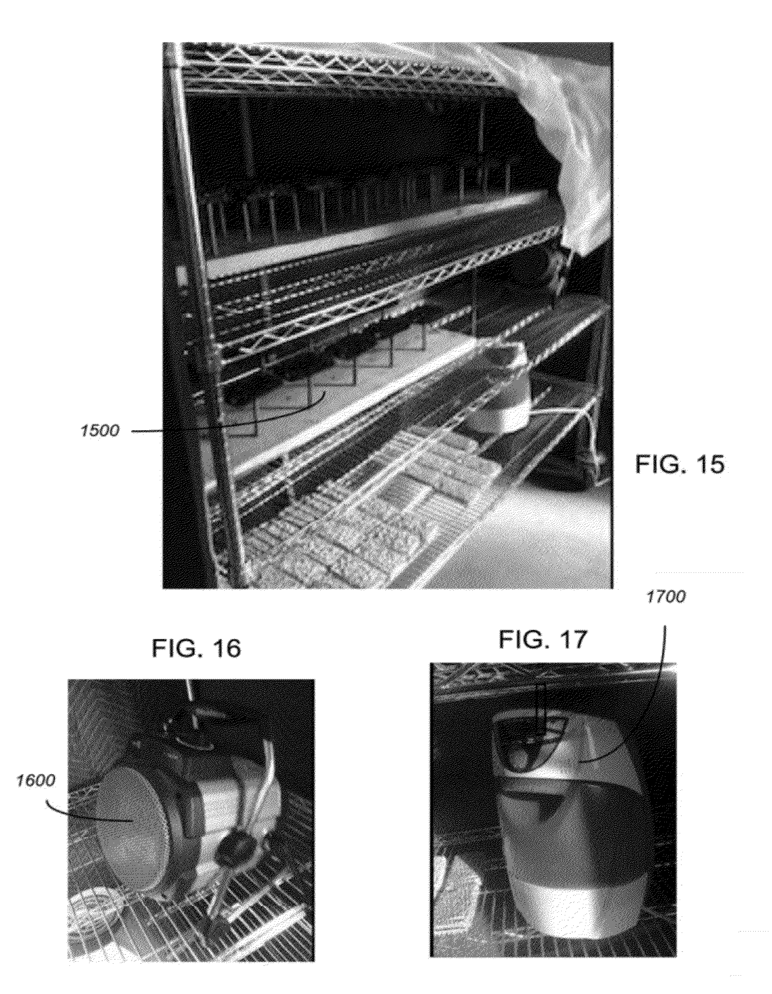

Immediately after spraying a mobile phone cover's painted silicone with a clear silicone, the mobile phone cover may be placed into a curing chamber 1500. See, FIG. 15. A curing chamber 1500 may be formed by draping a ventilated shelving unit in a durable plastic and providing the curing chamber with a heater 1600 (FIG. 16) and a humidifier 1700 (FIG. 17). Using the materials and processes disclosed in the preceding paragraphs, it has been found that a cure time of about twenty-four hours, at 100° Fahrenheit and 90% humidity, is useful.

After curing, the two pieces of the mobile phone cover will be joined by the silicone that covers the respective abutting surfaces of the two pieces. In some instances, the mobile phone cover may be distributed with the two pieces in this joined configuration, and the silicone that joins the two pieces may be separated (e.g., torn) when a user of the mobile device pulls the two pieces apart during a first use of the mobile phone cover.

### A Second Particular Example of a Method of Forming a Shock Absorbing Surface on an Object

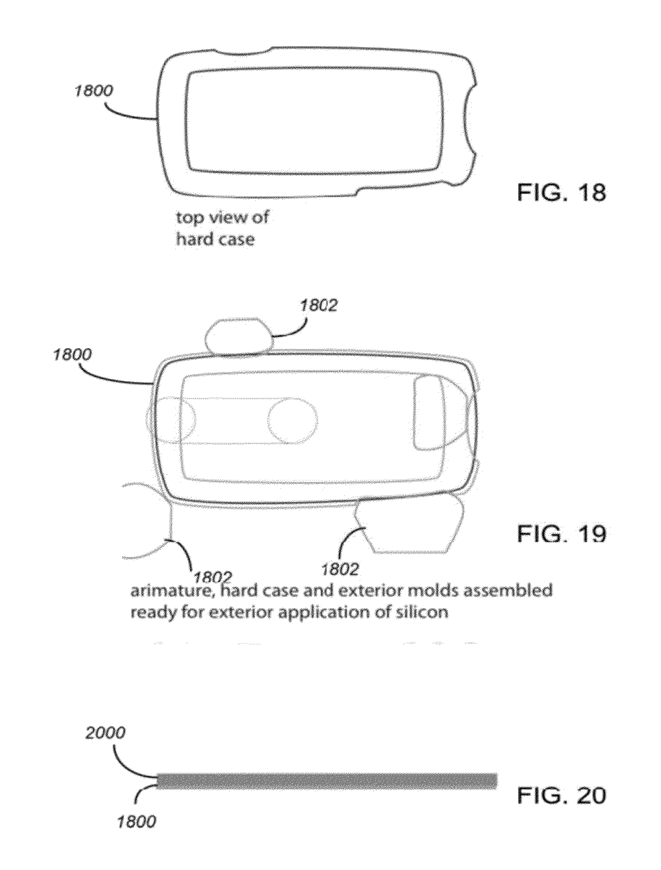

A second particular example of a method of forming a shock absorbing surface on an object is shown in FIGS. 18-24. The method includes the following steps:

1. mold preparation (prep)—apply mold release and mount hard-shell case to mold

2. mix the color, metallic flake, or other design element, if any, into the silicone that is to be applied to the particular unit

3. apply the silicone to the exterior surface of the hard-shell case

4. texture the silicone using a machine or tool and gravity

5. cure the textured silicone using room temperature vulcanization (RTV) or heat

6. remove the hard-shell case with textured material from the mold

Exemplary embodiments of these steps are described in greater detail below.

In Step 1, both halves of the hard-shell case 1800 are placed in a mold. One or more armatures similar to the actual phone are used to hold the halves of the hard-shell case. A number of exterior molds 1802, 1804, 1806 are then attached to the hard-shell case 1800. The exterior molds 1802, 1804, 1806 ensure that openings in the hard-shell case 1800 are uniformly preserved so that the textured material does not interfere with operation of ports and components that need to remain accessible (e.g., earphone or speaker connectors, a camera flash, a volume control switch, etc.). A mold release is applied to all components except the hard-shell case 1800. The mold release may be applied before or after the hard-shell case 1800 is placed in the mold. See FIGS. 18 & 19.

In Step 2, colors, metal flake, or other design elements for a particular unit, if any, are mixed together with silicone, or applied directly to the hard-shell case. In some embodiments, the mixing may be done by hand, which tends to give a wide range of texture scale, density of peaks, opacity/transparency, and range of reflectance. The silicone (typically clear, black or white) may be placed in a syringe (e.g., a 30 cc syringe) or other applicator device and mixed with a custom pigment for the final product color. Different syringes may be prepared for different colors. In some cases, differently colored silicones may be applied to different portions of the case, in random or purposeful patterns. Color and pattern options are numerous, but in some cases may include: 1) a dull, opaque black; 2) a whimsical pearl white with pink polkadots; 3) a translucent material imbedded with translucent blue pigments; or 4) a translucent material embedded with pigments that change color depending on the angle of the light reflected, with colors ranging from burgundy to gold, and green to metallic orange.

In Step 3, the surface of the hard-shell case 1800 is flooded with the colored silicone or other appropriate material (such as a rubber or plastic material), or one or more colored or non-colored silicones are purposefully applied to portions of the hard-shell case. To create unique color patterns, the silicone may be applied using syringes or other controllable applicators. In some embodiments, the colored silicone may first be applied to the hard-shell case around the exterior molds, and then applied to the remainder of the hard-shell case, to a depth of about 0.125″. The final texture of the silicone or other appropriate material can be controlled to some extent by selecting or controlling the viscosity, the slump, or the filler materials of the silicone. See, FIGS. 18-20, where FIG. 20 shows an elevation of the applied silicone 2000.

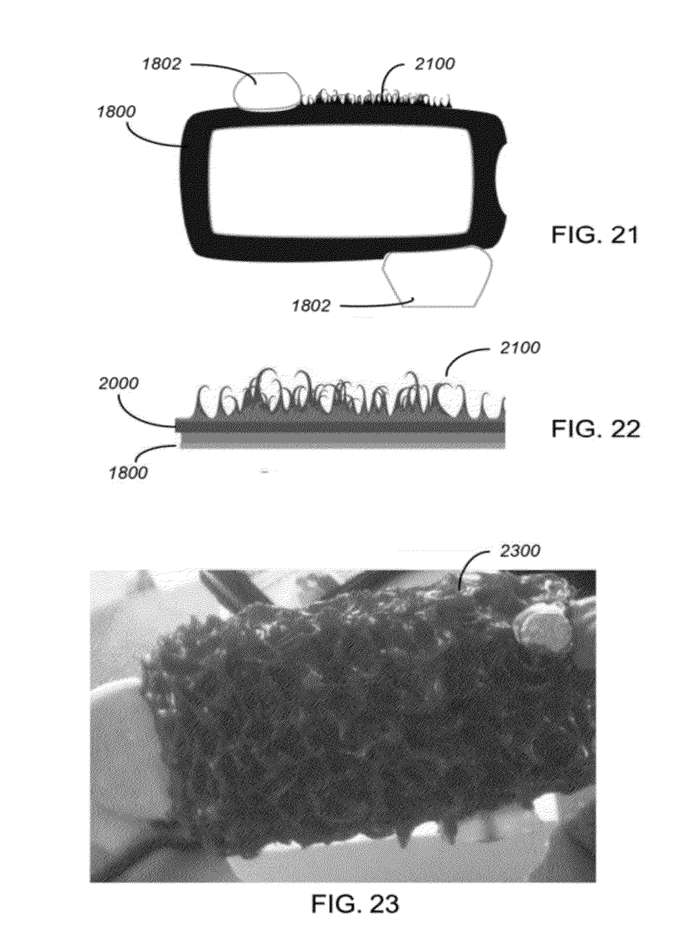

In Step 4, the surface of the applied silicone is pulled up using an appropriate machine or tool, such as a flat plate or rod. Pulling straight up, the silicone will follow the plate until it breaks surface tension from the silicone on the substrate. This will cause the silicone to fall back upon itself, forming a slumped peak shape 2100 (FIG. 21). By rotating the plate as it is pulled, the silicone peaks will form a different and distinct pattern that would be appropriate for different specific uses. Dropping the plate into the silicone multiple times (i.e., two or more times), and varying the speed at which the plate is pulled up, will continue to customize the shapes of the peaks, thereby forming a variety of different types of peaks. Dependent upon end use, the viscosity, slump, end cured durometer, and forming motions can be varied to create different unique surface textures. Each time the silicone is pulled, it will vary the shock absorbance, abrasion resistance, grip, and look and feel of the textured material. Peaks can be formed with shallow or deep, and uniform or irregular, characteristics. The viscosity and slump of the silicone, how the plate or other tool is dropped into and pulled away from the silicone, and other factors may be varied to control the size, direction and height of the formed peaks. The silicone is pulled before it is cured (or at least before it is fully cured). See, FIGS. 21 & 22.

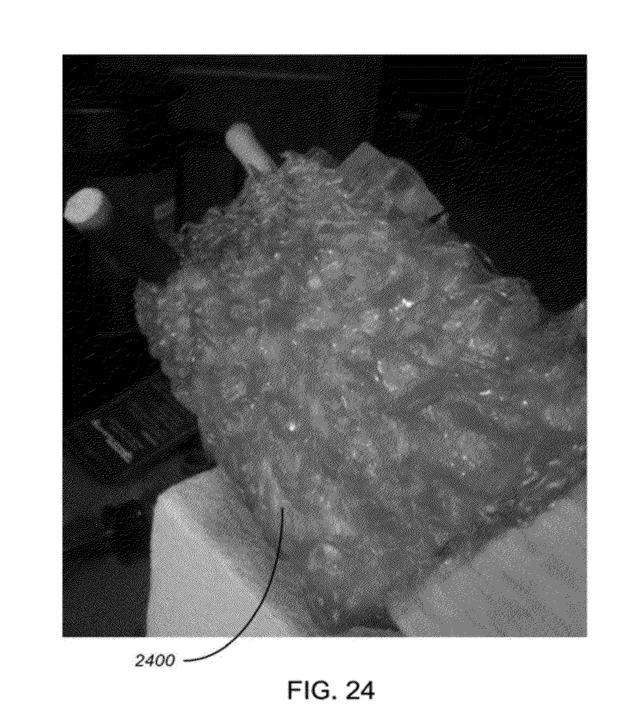

In steps 5 and 6, the finished product is removed from the mold and cured. Depending on the composition of the textured material, the material may be cured, for example, using room temperature vulcanizing or heat. For example, one-part silicones are typically cured using room temperature vulcanizing, while two-part silicones are typically cured in an oven (but more quickly). In some cases, a two-part silicone may be cured by placing it in a 150° F. convection oven. The textured material may be cured before or after the hard-shell case is removed from its mold(s). In some cases, extraneous portions of the textured material may be trimmed from the hard-shell case. Once the textured material is cured, the hard-shell case with textured material can be clipped onto a smart phone. Examples of finished mobile phone cases 2300, 2400 are shown in FIGS. 23 & 24. The cure may be timed or controlled to control the final hardness (durometer) of the finished product, and thereby, the elastomeric characteristics and peak slump of the finished product. Shore (Durometer) hardness of a plastic is most commonly measured by the Shore® (Durometer) test or Rockwell hardness test. Both methods measure the resistance of plastics toward indentation and provide an empirical hardness value that does not necessarily correlate well to other properties or fundamental characteristics. Shore hardness, using either the Shore A or Shore D scale, is the preferred method of characterizing rubbers/elastomers, and is also commonly used for softer plastics such as polyolefins. See, FIGS. 23 & 24.

Because the textured material disclosed herein will reduce the number of broken phones, it has a “Green Quality” to it. It will make it easier to find your phone because it has a tactile sensation to it. It is also a great icebreaker for conversations, as it is so unique looking, it creates conversations.

### Other Uses for the Textured Material, and Other Ways to Form Same

The textured material described herein is not limited to use on mobile devices or their cases. It can be used in a wide variety of applications, such as protective wraps for cameras and lenses, unique tile floors for infant protection, or playground flooring. Examples of other uses include: as a coating on stress balls, as a steering wheel cover, as a knife handle cover, as a shower mat surface, on a sunglasses case, as surfboard grip tape, as pencil or pen grips, as a water bottle sleeve, as a coffee cup sleeve, as a flip-flop sole covering, as a shoe insert, as a television or other electronics item remote control cover, as a non-slide tape strip, as a covering on the bottom of a baby dish, as a cigarette lighter cover, as a mat (kitchen, shed, workshop, etc.), as a gaming remote control cover, as a massage device, on an evening clutch or purse, on a coin clutch, as an automobile bumper guard, as an anti-slip mat or tile, or as a tool drawer liner

The texture and thickness of the textured material can be varied significantly. Additionally, the hardness of the end product can be controlled (e.g., by changing cure parameters, changing the chemical composition of the material, or controlling final Shore hardness). As a result, textured material may be produced for protecting a light-weight product such as an iPod® mini from the type of shocks expected from a common fall from hand to asphalt, or from pocket to tile, while providing scratch-free protection. Or, textured material having a heavier texture for protecting a heavier product may be produced. A heavier texture/product (e.g., one with a different durometer (hardness)) may be produced for protecting something like a telephoto lens.

Although the textured material described herein suits itself to protecting mobile devices, the textured material can be used in various other applications, such as, for example, to cover floor tiles that are used in a child's room to provide shock absorption, grip, and resistance to most common fluids, almost abrasion free with a life time approaching 50 years and a temperature range below freezing to exceeding 300 degrees Fahrenheit. Such a floor tile can be produced by the following exemplary method:

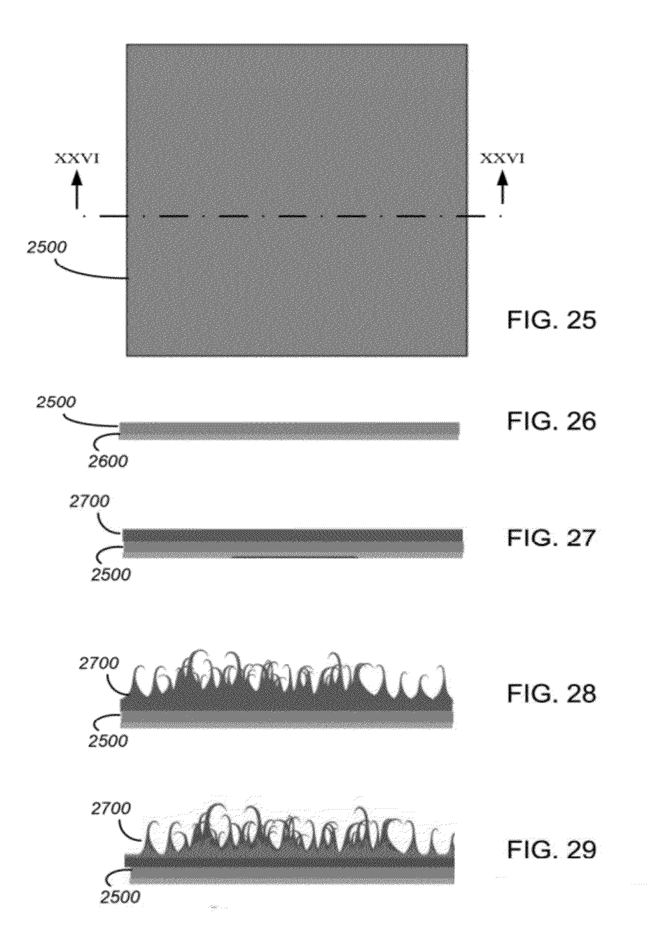

In Step A: Start with a suitable substrate 2500 (e.g., 0.250″ dense foam). See, FIG. 25.

In Step B: Attach an adhesive back 2600. See, FIG. 26.

In Step C: Flood surface of substrate with silicone or other appropriate material 2700. The thickness, viscosity, slump and cure durometer can be selected dependent upon end use. See, FIG. 27.

In Step D: Pull up the surface of the applied silicone using an appropriate machine or tool, such as a flat plate, rod or finger. Pulling straight up, the silicone will follow the plate until it breaks surface tension from the silicone on the substrate. This will cause the silicone to fall back upon itself, forming a slumped peak shape. By rotating the plate as it is pulled, the silicone peaks will form a different and distinct pattern that would be appropriate for different specific uses. Dropping the plate into the silicone multiple times (i.e., two or more), and varying the speed at which the plate is pulled up, will continue to customize the shapes of the peaks, forming a variety of different types of peaks. Dependent upon end use, the viscosity, slump, end cured durometer and forming motions can be varied to create different unique surface textures. Each time the silicone is pulled, it will vary the shock absorbance, abrasion resistance, grip, and look and feel of the textured material. Peaks can be formed with shallow or deep and uniform or irregular characteristics. The viscosity and slump of the silicone, how the plate or other tool is dropped into and pulled away from the silicone, and other factors may also be varied to control the size, direction and height of the formed peaks. The silicone is pulled before it is cured (or at least before it is fully cured). The silicone may then be cured to produce the tile product shown in elevation in FIG. 28 or 29.

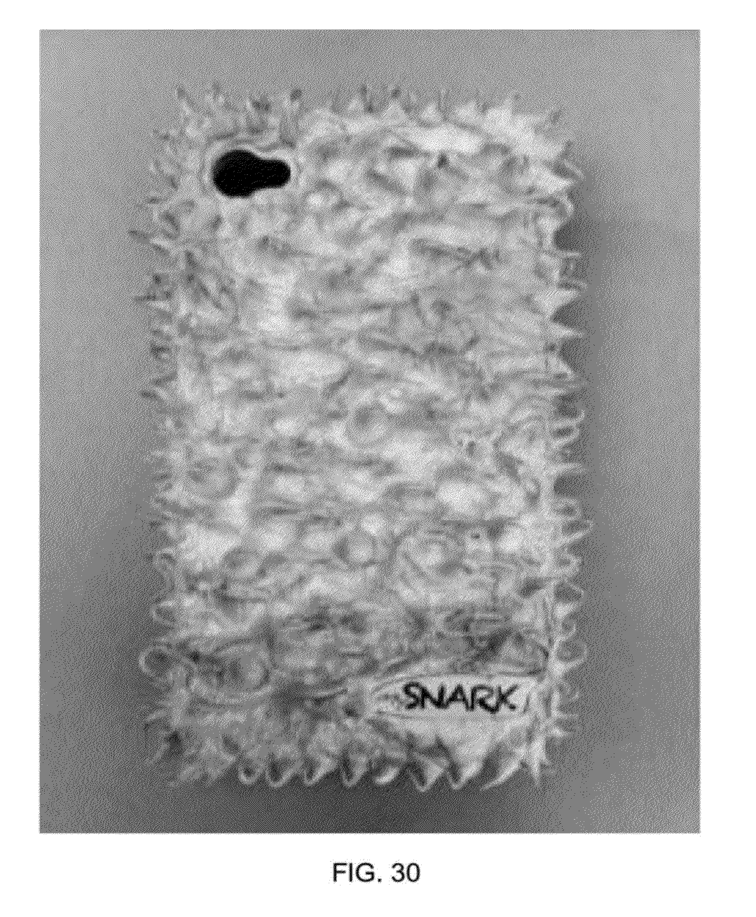

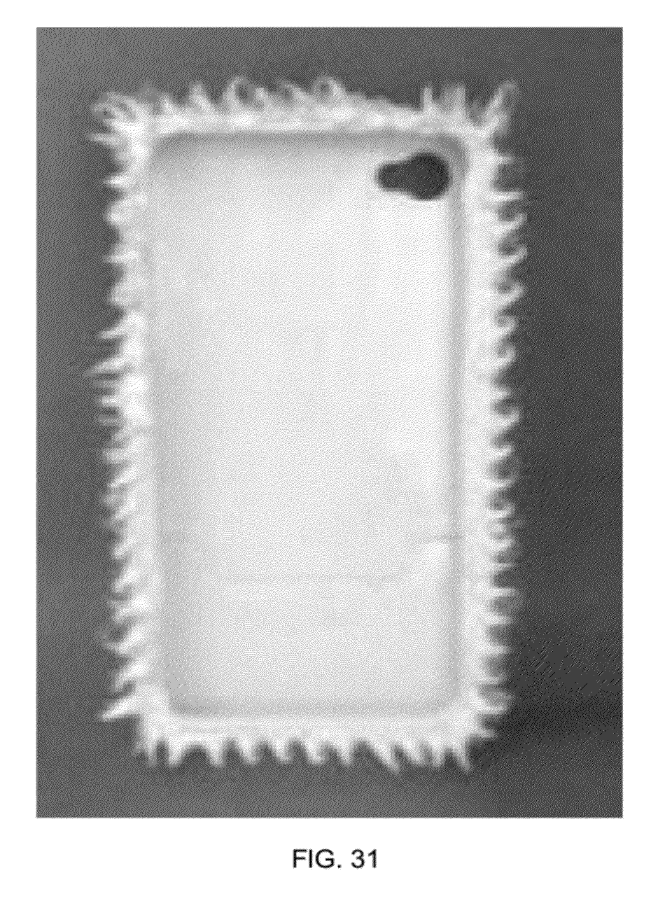

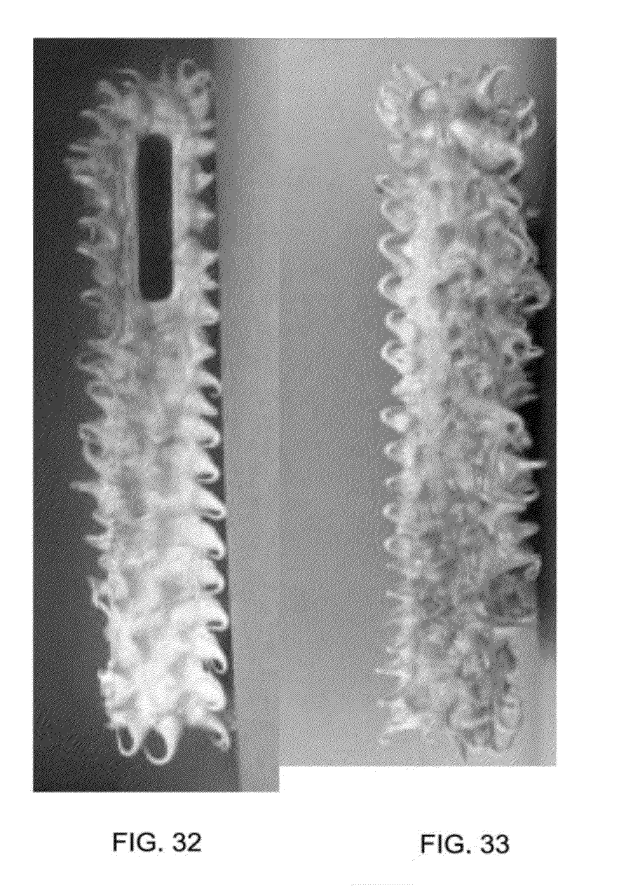

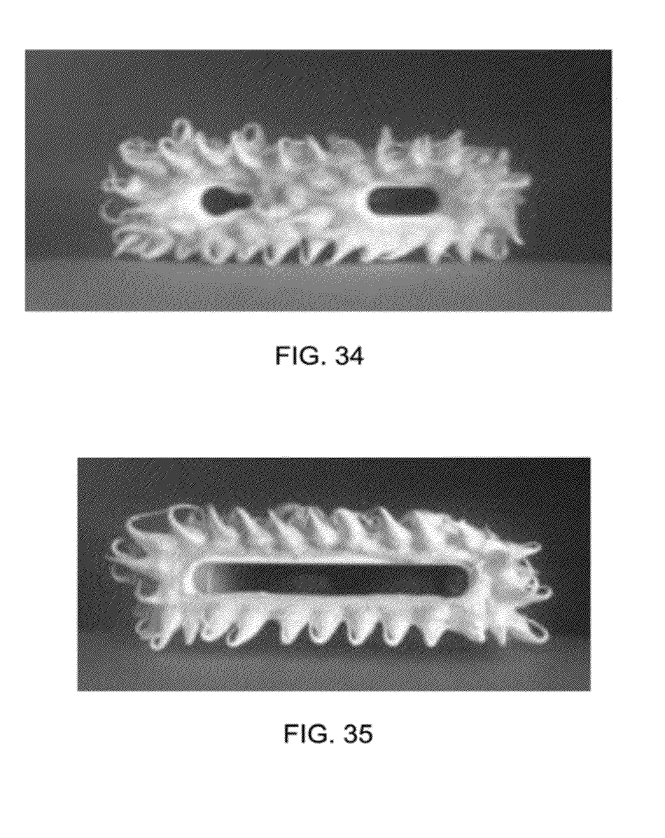

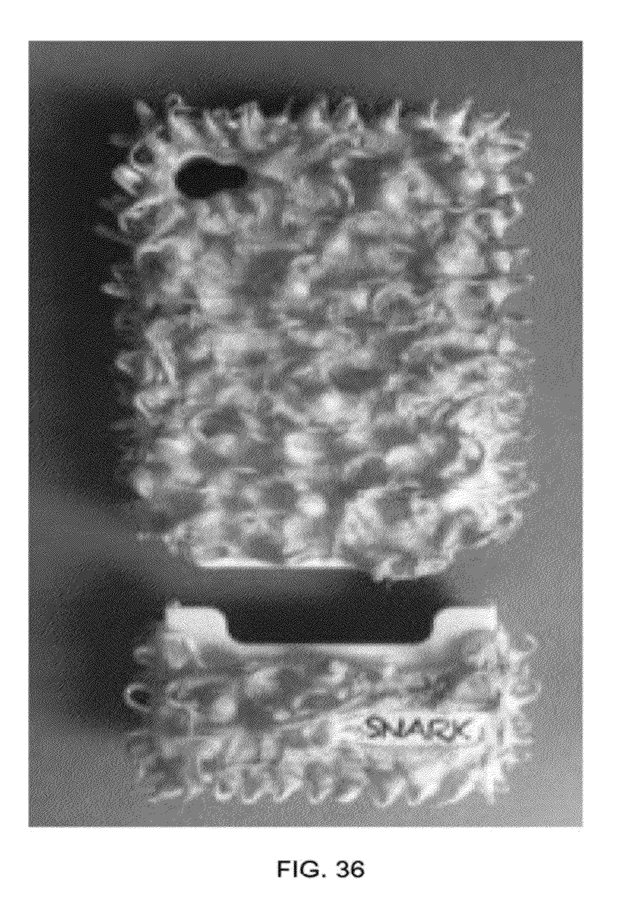

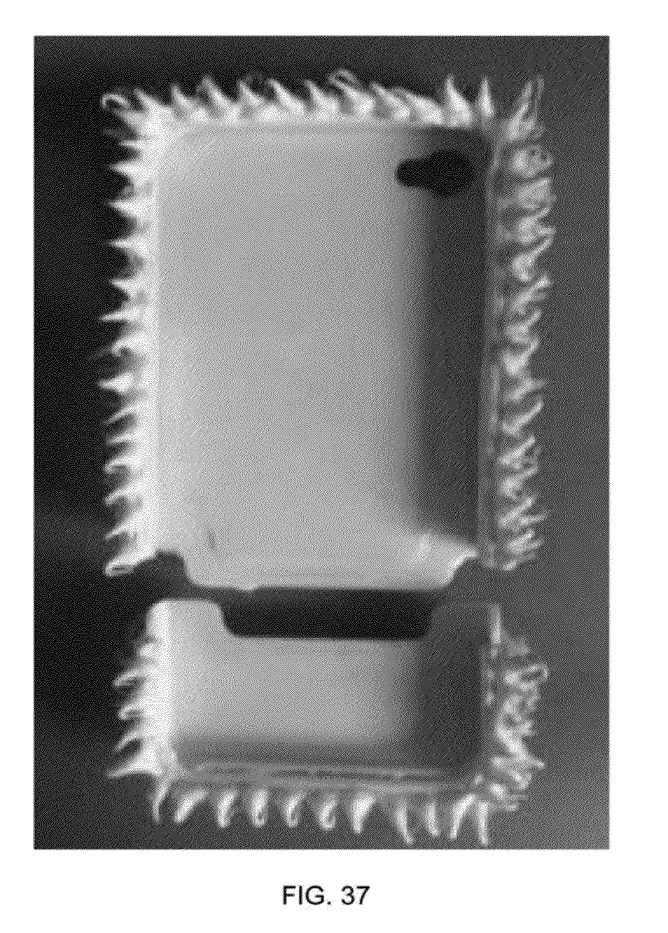

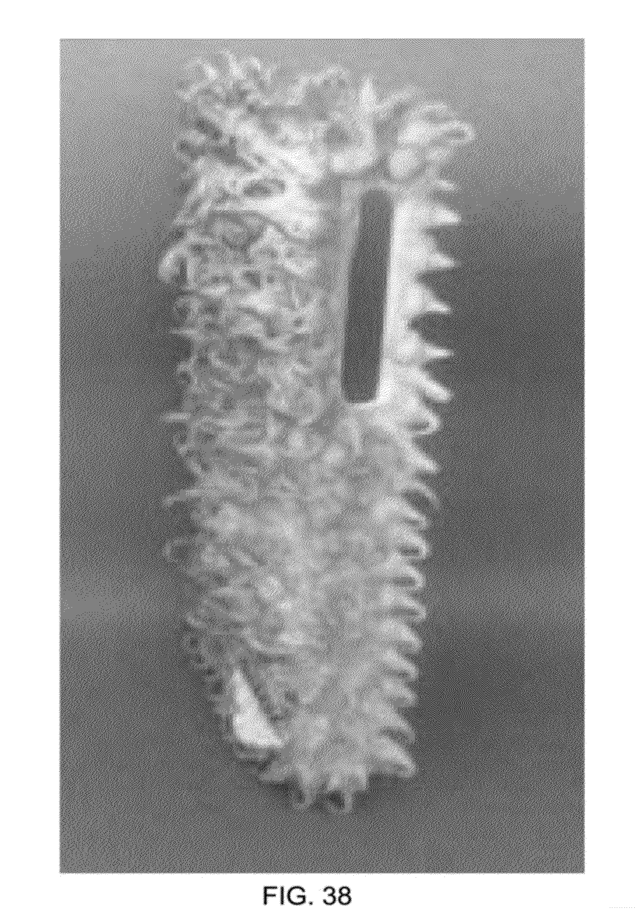

By way of example, and to illustrate in more detail a product that can be made using the teachings disclosed herein, FIGS. 30-38 illustrate an embodiment of a mobile device accessory (and in particular, a mobile phone cover) formed by pulling up on silicone that covers the entirety of an exterior surface of the mobile phone cover.

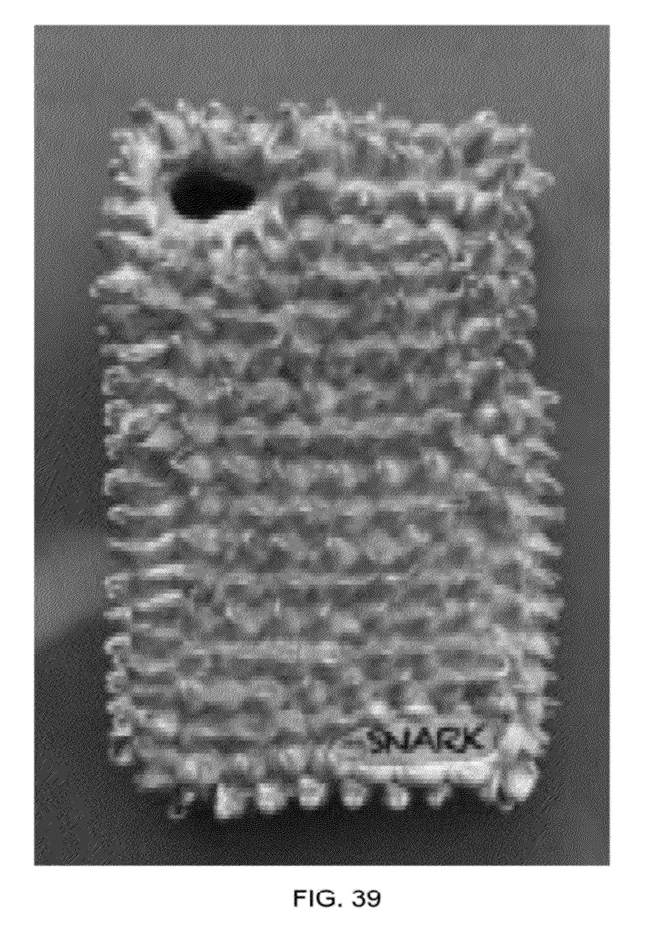

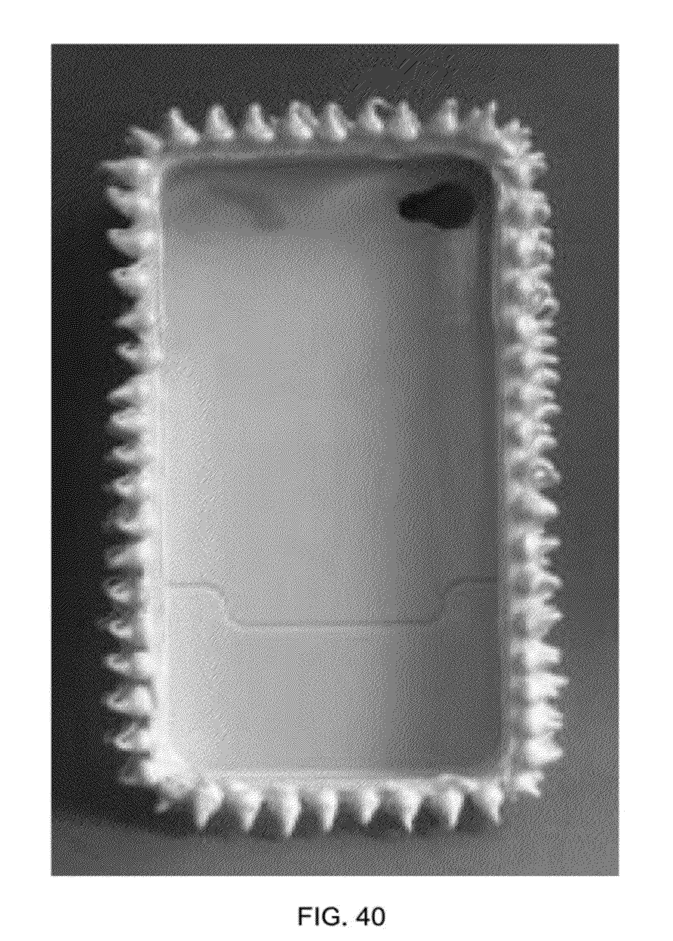

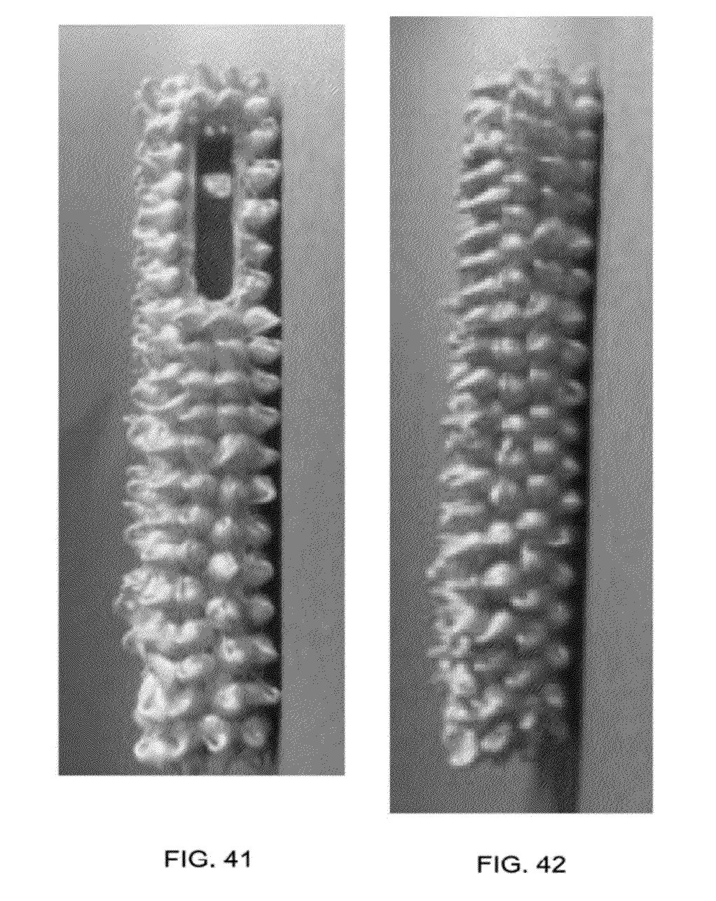

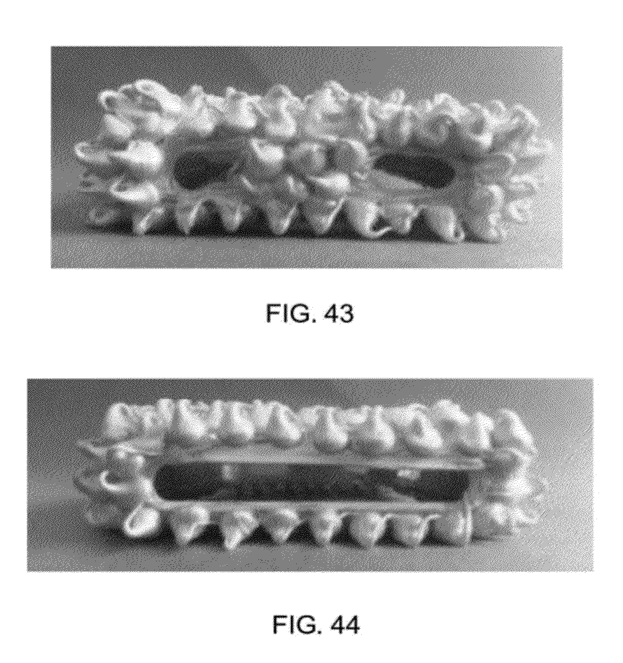

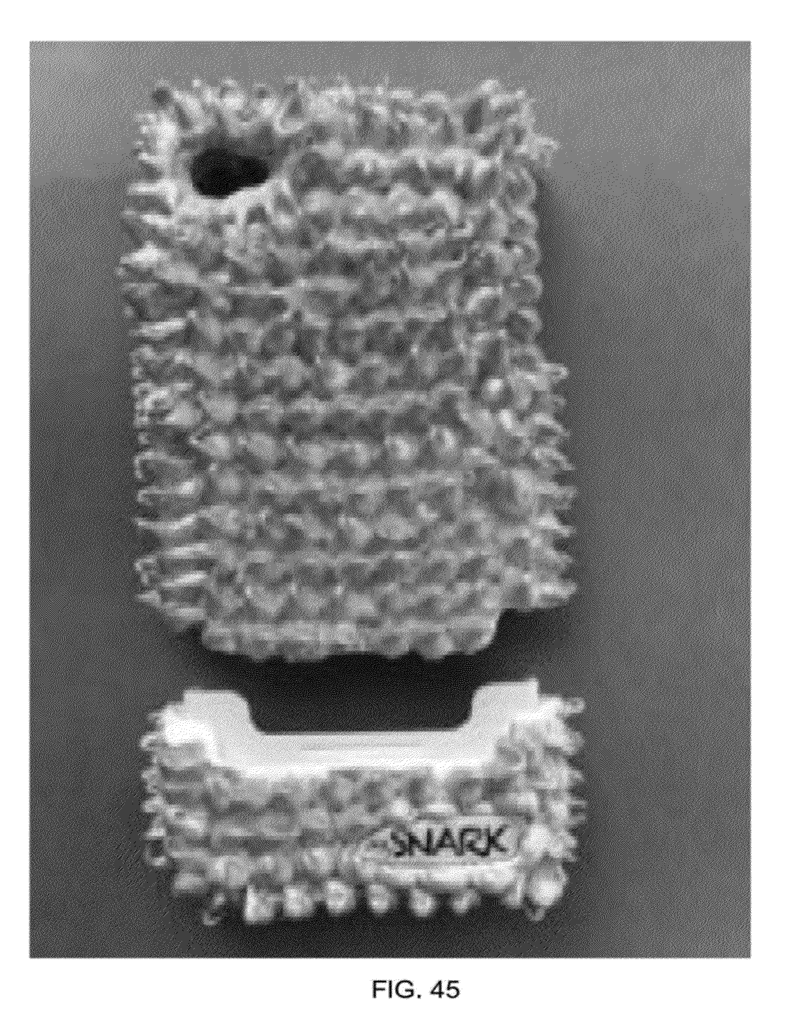

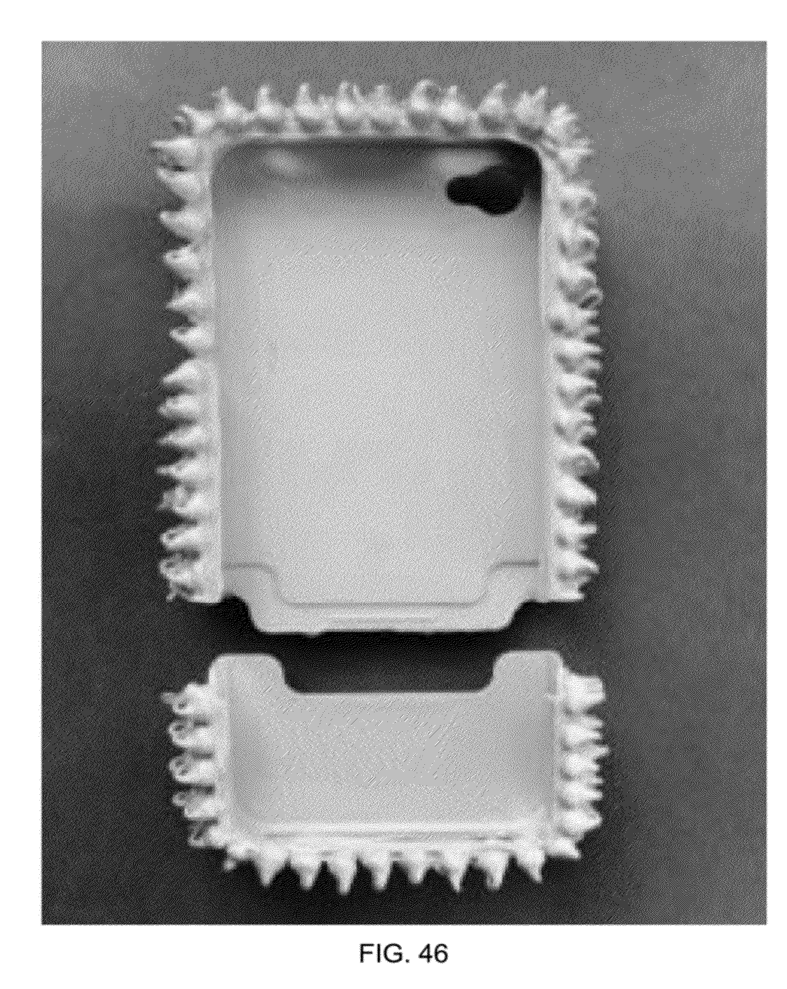

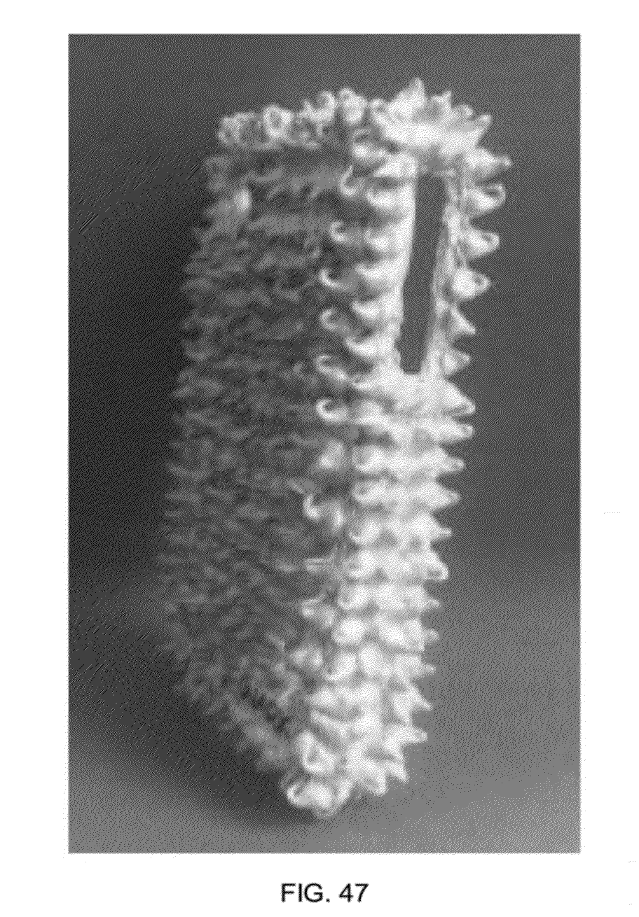

FIGS. 39-47 illustrate another embodiment of a mobile device accessory that can be made using the teachings disclosed herein. The accessory shown in FIGS. 39-47 is a mobile phone cover formed by depositing a coating of silicone primer on the cover, then depositing discrete quantities of silicone on top of the primer, and then pulling each discrete quantity of silicone to form a slumped peak.

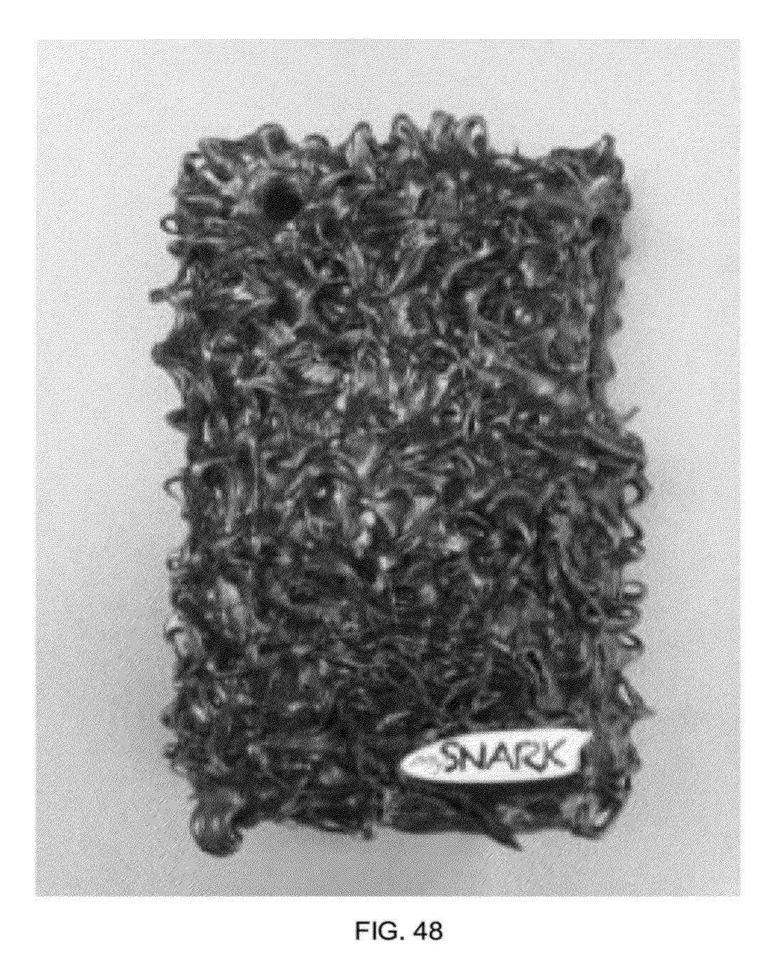

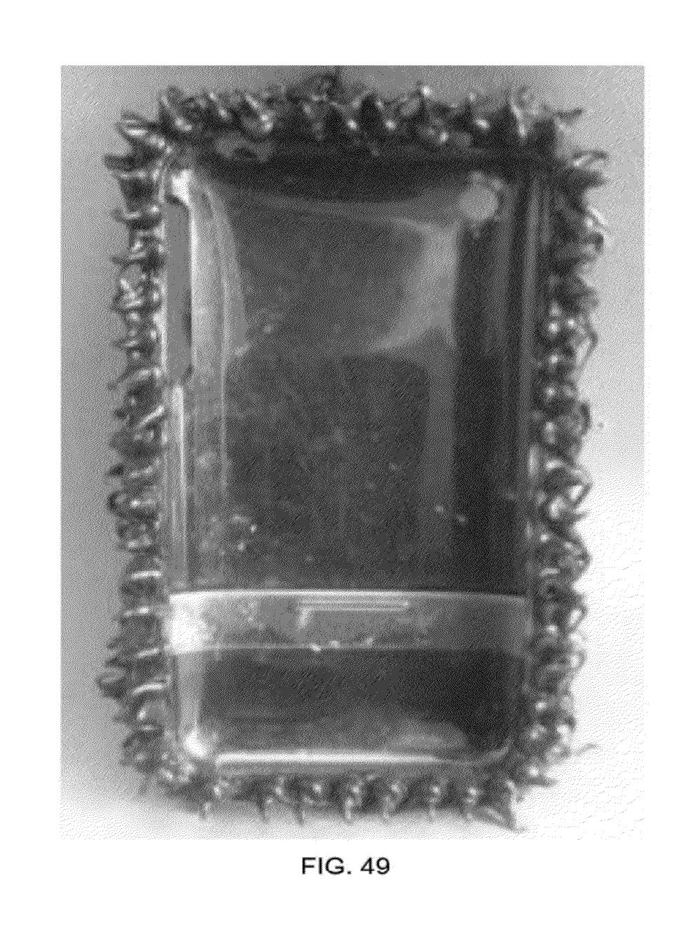

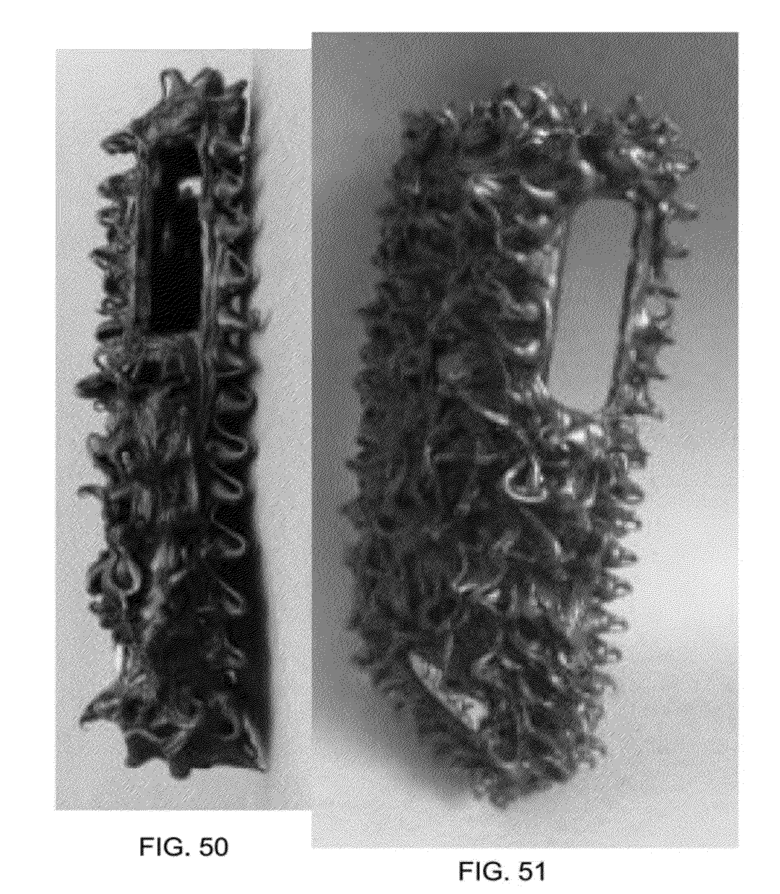

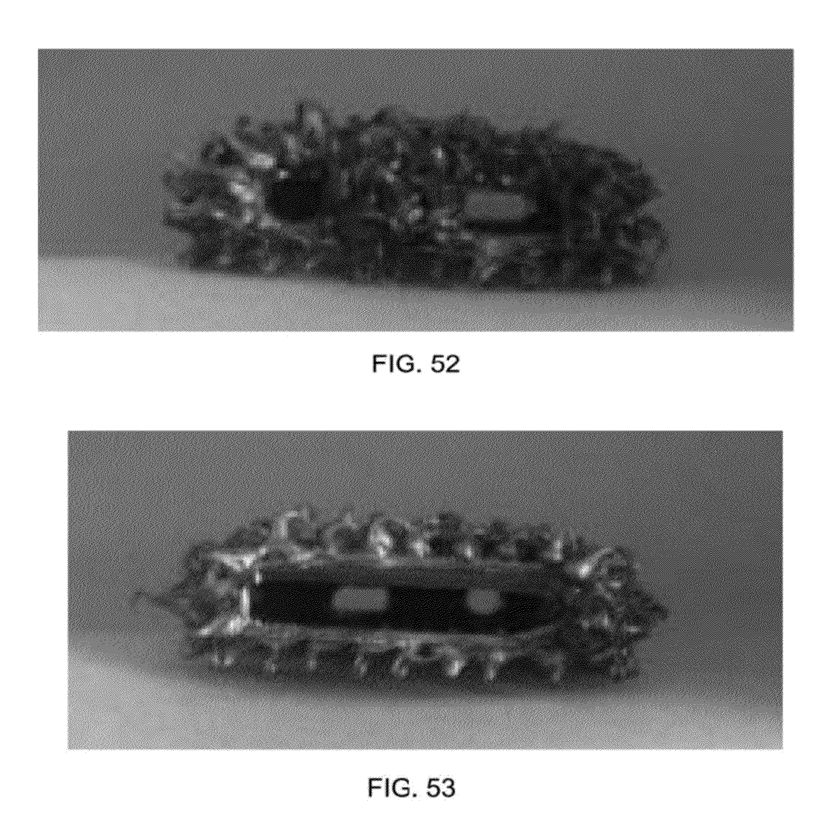

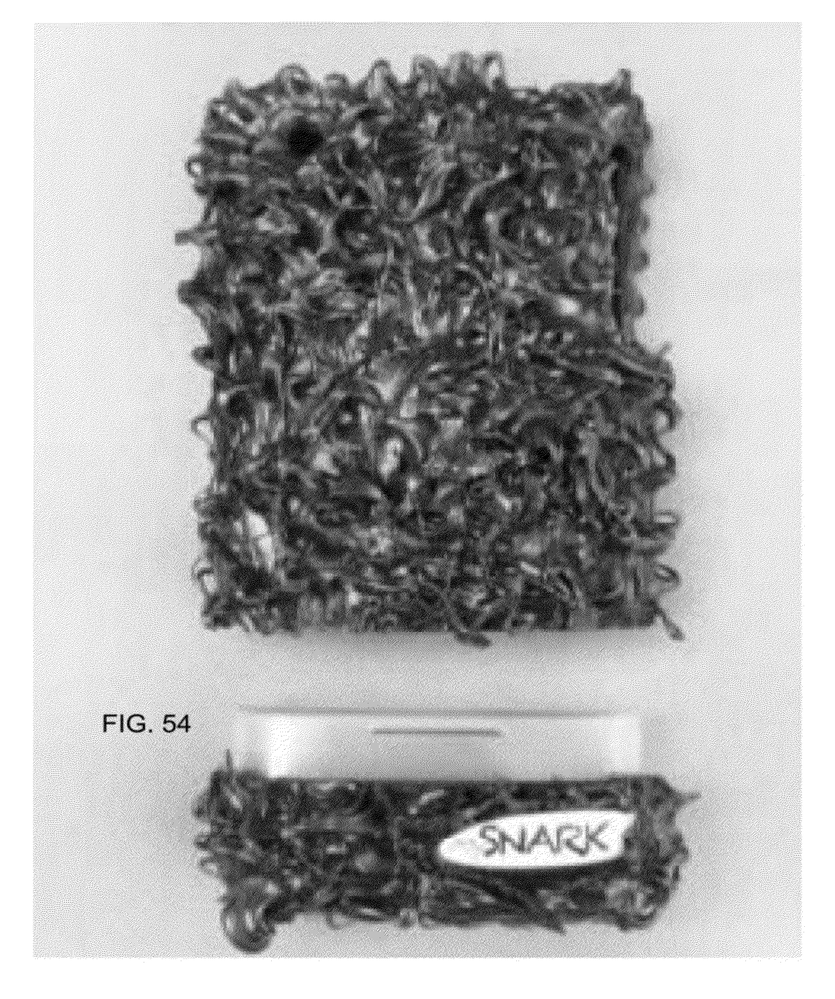

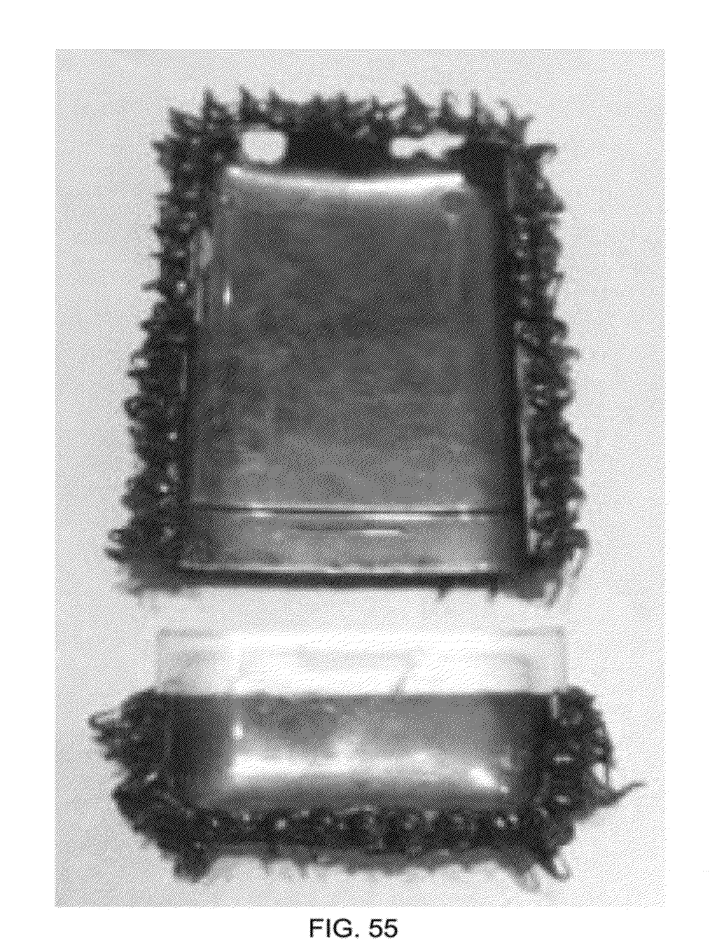

FIGS. 48-55 illustrate yet another embodiment of a mobile device accessory that can be made using the teachings disclosed herein. The accessory is another mobile phone cover formed by pulling up on silicone that covers the entirety of an exterior surface of the mobile phone cover.

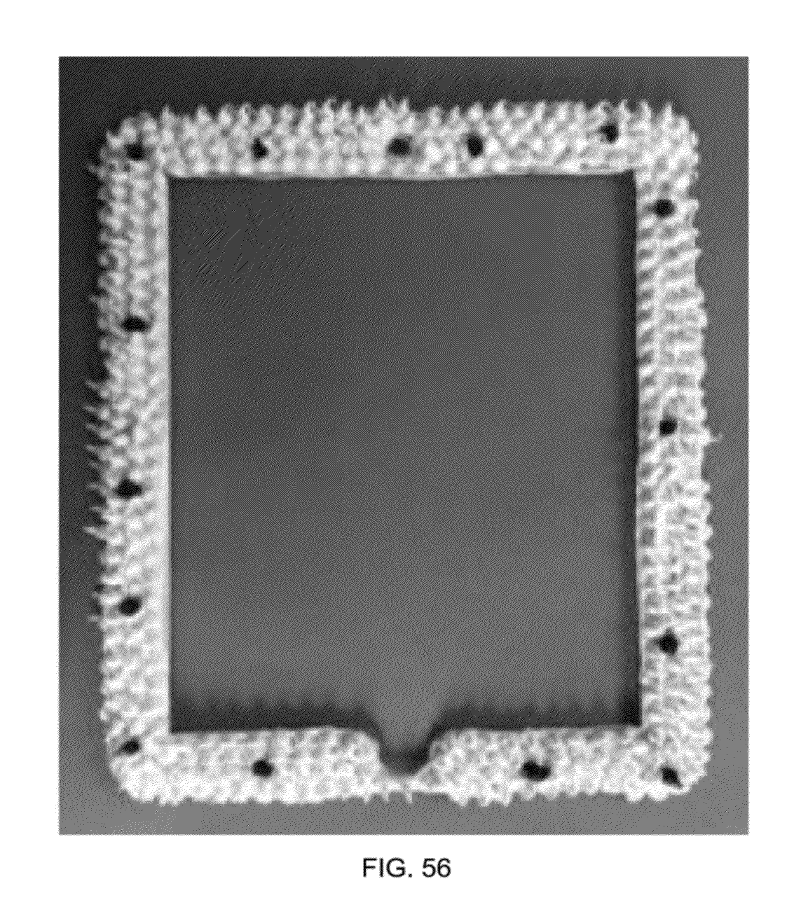

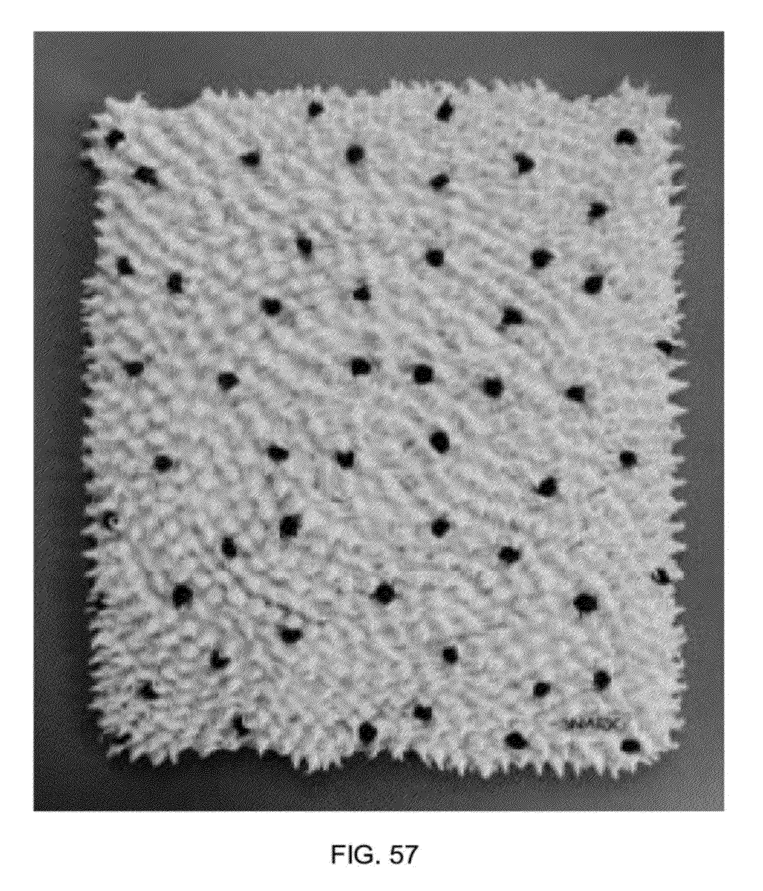

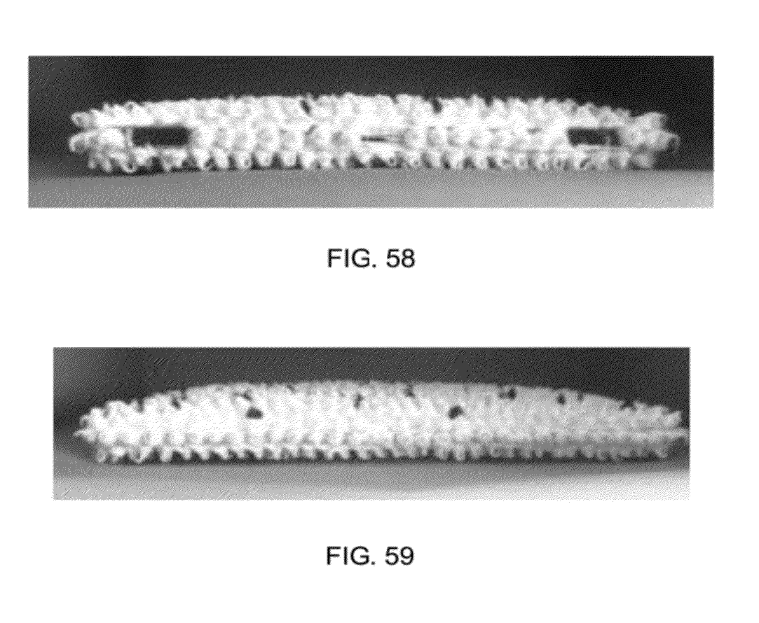

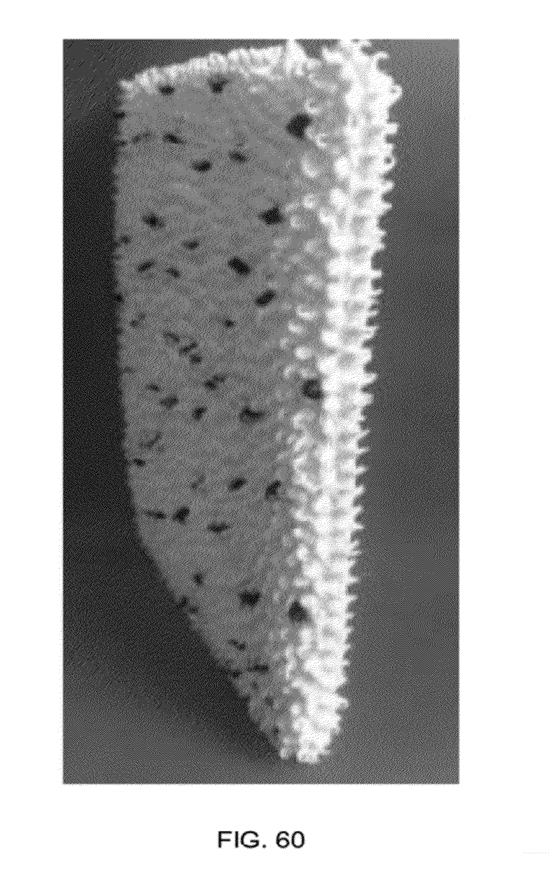

FIGS. 56-60 illustrate a further embodiment of a mobile device accessory that can be made using the teachings disclosed herein, and in particular, an Apple iPad cover formed by depositing a coating of silicone primer on the cover, then depositing discrete quantities of silicone on top of the primer, and then pulling each discrete quantity of silicone to form a slumped peak. The cover shown in FIGS. 56-60 also illustrates the deposition of discrete quantities of silicone having two different colors.

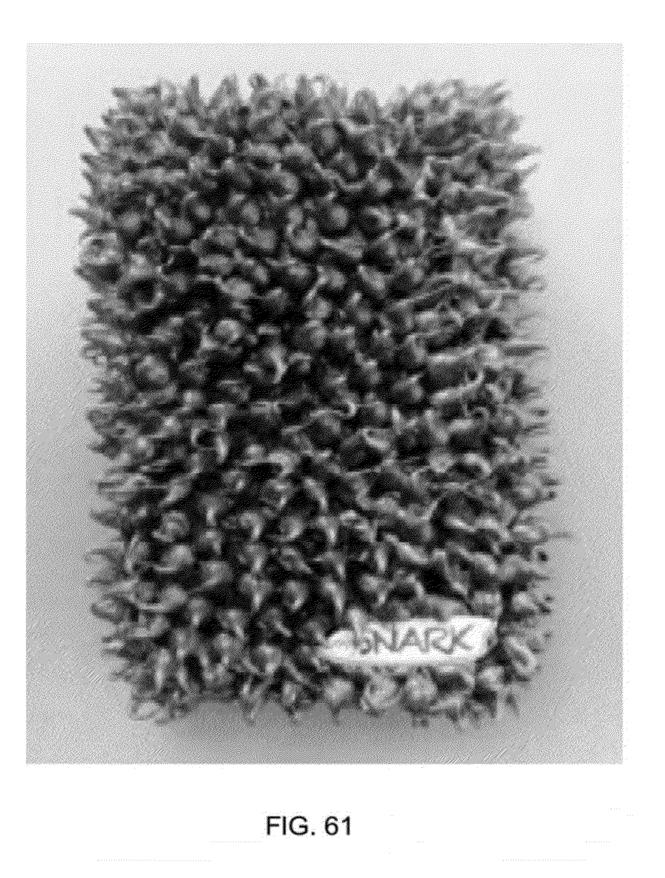

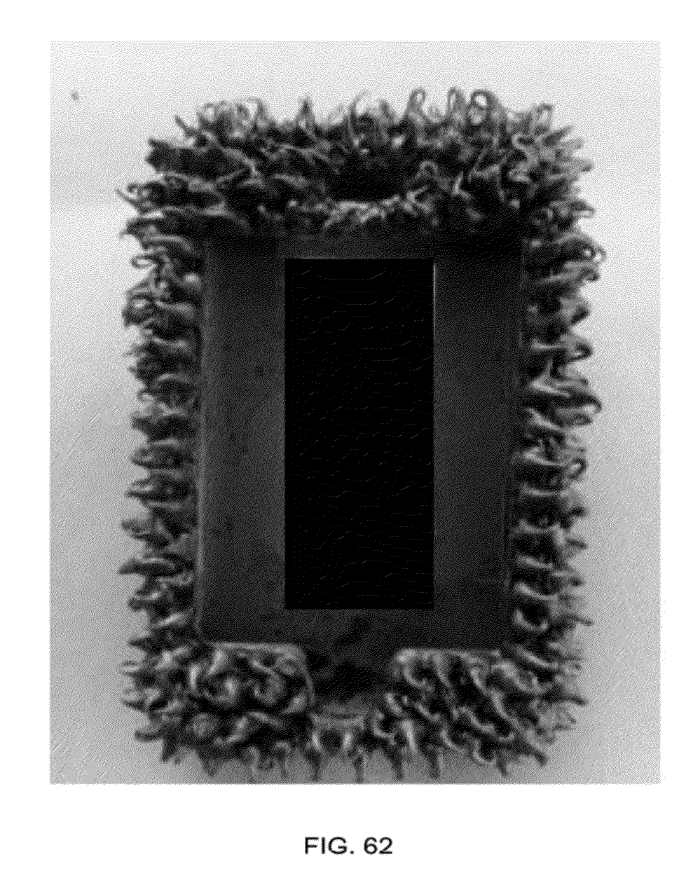

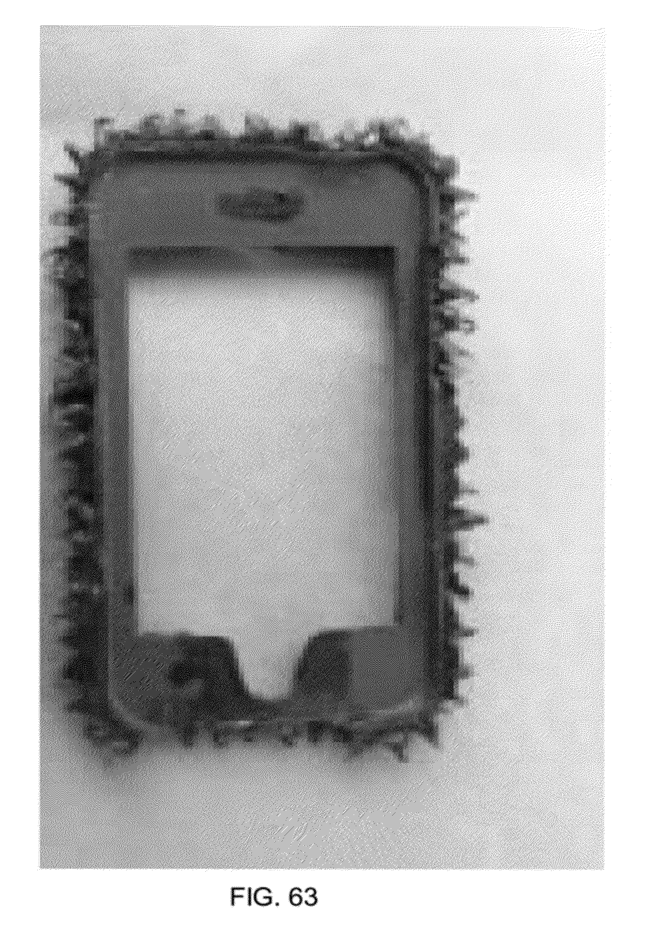

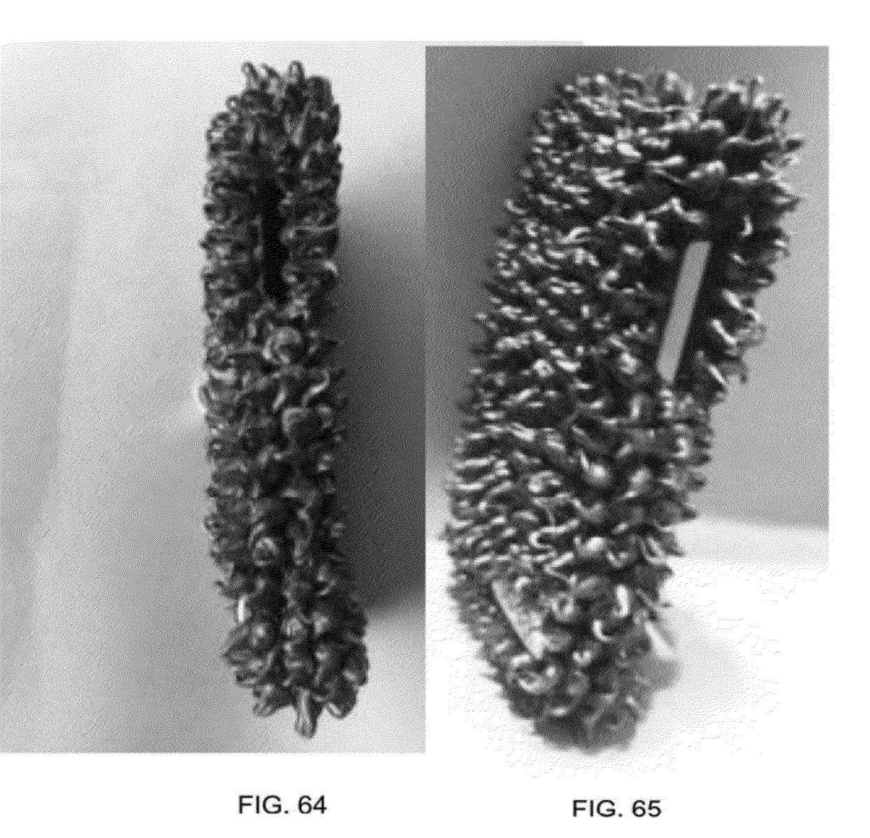

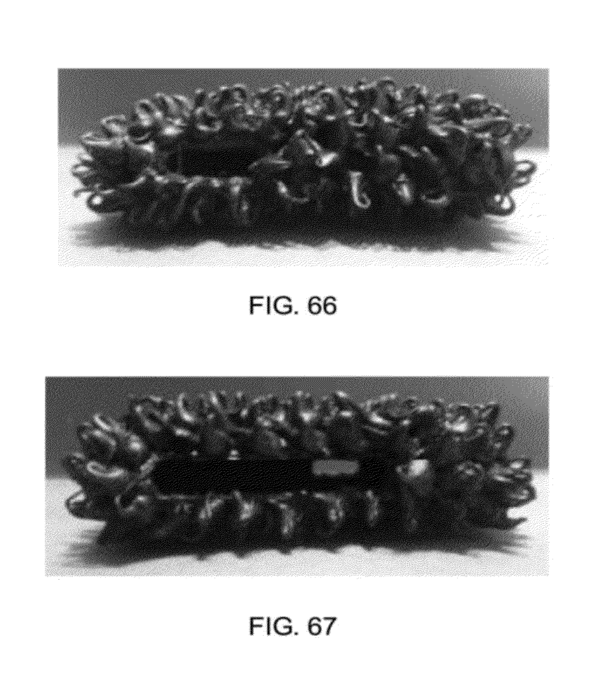

FIGS. 61-67 illustrate a still further embodiment of a mobile device accessory that can be made using the teachings disclosed herein. The accessory is an Apple iPod Touch cover (i.e., a portable music player cover). The cover is formed by depositing a coating of silicone primer on the cover, then depositing discrete quantities of silicone on top of the primer, and then pulling each discrete quantity of silicone to form a slumped peak.

1. A mobile device accessory, comprising:
a mobile device cover defining a mobile device receiving region; and
a resilient material on the mobile device cover, the resilient material defining a plurality of peaks extending generally away from the mobile device receiving region, the plurality of peaks increasing the surface area of the mobile device cover and providing shock absorption.

2. The mobile device accessory of claim 1, wherein the resilient material comprises silicone.

3. The mobile device accessory of claim 1, wherein the resilient material is entirely silicone.

4. The mobile device accessory of claim 1, wherein the resilient material comprises an elastomeric material.

5. The mobile device accessory of claim 1, wherein the resilient material comprises natural rubber.

6. The mobile device accessory of claim 1, wherein the mobile device cover is a rigid cover.

7. The mobile device accessory of claim 1, wherein the mobile device cover is a hard-shell case having two pieces.

8. The mobile device accessory of claim 1, wherein the mobile device cover is a flexible cover.

9. The mobile device accessory of claim 1, wherein the mobile device cover is a mobile phone cover.

10. The mobile device accessory of claim 1, wherein the mobile device cover is a portable music player cover.

11. The mobile device accessory of claim 1, wherein at least some of the peaks have tips that slump.

12. The mobile device accessory of claim 1, wherein at least some of the peaks comprise generally teardrop-shaped volumes of the resilient material, the generally teardrop-shaped volumes having flattened bases attached to the mobile device cover.

13. The mobile device accessory of claim 1, wherein at least some of the peaks form a meringue-like texture.

14. The mobile device accessory of claim 1, wherein the peaks are distributed non-uniformly over the mobile device cover.

15. The mobile device accessory of claim 1, wherein the mobile device cover has a plurality of panels that define the mobile device receiving region.

16. A mobile device accessory, comprising:
a mobile device cover defining a mobile device receiving region; and
a resilient material on the mobile device cover, the resilient material defining a plurality of protrusions extending generally away from the mobile device receiving region, the plurality of protrusions increasing the surface area of the mobile device cover and providing shock absorption.

17. A device accessory, comprising:
a flexible sheet having a first side opposite a second side;
a tacky or adhesive backing on the first side of the flexible sheet, the tacky or adhesive backing configured for application to a device; and
a resilient material on the second side of the flexible sheet, the resilient material defining a plurality of peaks extending generally away from the flexible sheet, the plurality of peaks increasing the surface area of the second side of the flexible sheet and providing shock absorption.

18. The device accessory of claim 17, wherein the flexible sheet is a dense foam.

19. The device accessory of claim 17, wherein the resilient material comprises silicone.

20. The device accessory of claim 17, wherein the resilient material is entirely silicone.

21. The device accessory of claim 17, wherein at least some of the peaks have tips that slump.

22. The device accessory of claim 17, wherein at least some of the peaks comprise generally teardrop-shaped volumes of the resilient material, the generally teardrop-shaped volumes having flattened bases attached to the flexible sheet.

23. An object, comprising:
a surface; and
a resilient material on the surface, the resilient material defining a plurality of peaks extending generally away from the surface, the plurality of peaks increasing the surface area of the surface and providing shock absorption.

24. The object of claim 23, wherein the object is a tile, and wherein the surface is a surface of the tile.

25. The object of claim 23, wherein the resilient material comprises silicone.

26. The object of claim 23, wherein the resilient material is entirely silicone.

27. The object of claim 23, wherein at least some of the peaks have tips that slump.

28. The object of claim 23, wherein at least some of the peaks comprise generally teardrop-shaped volumes of the resilient material, the generally teardrop-shaped volumes having flattened bases attached to the surface.

29. A method of forming a shock absorbing surface on an object, the method comprising:
applying a liquid, pliable material to a surface of an object;
pulling on the liquid, pliable material to form peaks extending generally away from the surface; and
curing the liquid, pliable material to form the shock absorbing surface.

30. The method of claim 29, wherein the liquid, pliable material is pulled at a viscosity and slump that cause tips of the peaks to slump.

31. The method of claim 29, wherein the liquid, pliable material is pulled up while the liquid, pliable material is facing up with respect to gravitational pull.

32. The method of claim 29, wherein the liquid, pliable material is pulled down while the liquid, pliable material is facing down with respect to gravitational pull.

33. The method of claim 29, further comprising:
mixing a colorant into the liquid, pliable material, before applying the liquid, pliable material to the object.

34. The method of claim 29, further comprising:
mixing a metallic flake into the liquid, pliable material, before applying the liquid, pliable material to the object.

35. The method of claim 29, further comprising:
hand-mixing a design element into the liquid, pliable material, before applying the liquid, pliable material to the object, the hand-mixing providing a non-uniform distribution of the design element in the liquid, pliable material.

36. The method of claim 29, further comprising:
applying a colorant to the object, before applying the liquid, pliable material to the object.

37. The method of claim 29, further comprising:
applying a metallic flake to the object, before applying the liquid, pliable material to the object.

38. The method of claim 29, wherein the object is a mobile device cover having two pieces, the method further comprising:
applying the liquid, pliable material to the mobile device cover, and pulling on the liquid, pliable material to form peaks, while the two pieces of the mobile device cover are joined.

39. The method of claim 29, wherein the liquid, pliable material is applied to the object and pulled using an applicator tip.

40. The method of claim 29, wherein:
the liquid, pliable material includes a first type of liquid, pliable material and a second type of liquid, pliable material;
the first type of liquid, pliable material is applied in discrete quantities to portions of the surface of the object, and pulled, using a first applicator tip; and
the second type of liquid, pliable material is applied in discrete quantities to portions of the surface of the object, and pulled, using a second applicator tip.

41. The method of claim 29, wherein:
a first quantity of the liquid, pliable material is applied as a coating on the surface of the object; and
a second quantity of the liquid, pliable material is applied in discrete quantities on top of the coating, and pulled, using an applicator tip.

42. The method of claim 29, wherein the first and second portions of the liquid, pliable material have differing characteristics.

43. The method of claim 29, wherein the liquid, pliable material is pulled by contacting the liquid, pliable material with a plate and then pulling the plate away from the liquid, pliable material.

44. The method of claim 29, wherein the liquid, pliable material is pulled by contacting the liquid, pliable material with a rod and then pulling the rod away from the liquid, pliable material.

45. The method of claim 29, wherein the liquid, pliable material is pulled by contacting the liquid, pliable material with a plate multiple times, and varying a manner in which the plate is pulled away from the liquid, pliable material.

46. The method of claim 29, wherein the liquid, pliable material comprises silicone.

47. The method of claim 29, wherein the liquid, pliable material is entirely silicone.

48. A method of forming a shock absorbing surface on an object, the method comprising:
applying a liquid, pliable material to a surface of an object;
pulling on the liquid, pliable material to form protrusions extending generally away from the surface; and
curing the liquid, pliable material to form the shock absorbing surface.

49. A method of distributing a mobile device cover having two pieces, comprising:
distributing the two pieces in a joined configuration, the two pieces being i) joined as they would be when the mobile device cover receives a mobile device, and ii) joined by a resilient material that covers respective abutting surfaces of the two pieces, the resilient material being separable by a user of the mobile device upon pulling the two pieces apart during a first use of the mobile device cover.
